(19) United States
(12) Patent Application Publication
(10) Pub. No.: US 2026/0113578 A1
(43) Pub. Date: Apr. 23, 2026

(54) INFORMATION PROCESSING SYSTEM, DEVICE, INFORMATION PROCESSING METHOD, AND PROGRAM

(71) Applicant: Sony Group Corporation, Tokyo (JP)

(72) Inventors: Kyosuke MATSUMOTO, Tokyo (JP); Shinpei TSUCHIYA, Tokyo (JP); Tetsunori ITABASHI, Tokyo (JP); Yuji TOKOZUME, Tokyo (JP)

(73) Assignee: Sony Group Corporation, Tokyo (JP)

(21) Appl. No.: 19/117,248

(22) PCT Filed: Aug. 29, 2023
(86) PCT No.: PCT/JP2023/031128

§ 371 Date: Mar. 31, 2025

(30) Foreign Application Priority Data
Oct. 7, 2022 (JP) 2022-162374

(51) Int. Cl. H04R 25/00

(52) U.S. Cl. CPC H04R 25/505

(57) ABSTRACT

An information processing system includes: a plurality of devices participating in a local communication network, in which the plurality of devices includes: a first device used by a first user, the first device functioning as a detection device that detects utterance of the first user; and a second device used by a second user, the second device functioning as a hearing aid device that executes hearing aid processing, the first device transmits an utterance flag indicating presence or absence of utterance to the second device, and the second device turns on the hearing aid processing in a case where the utterance flag indicates presence of utterance.

### FIELD

The present disclosure relates to an information processing system, a device, an information processing method, and a program.

### BACKGROUND

For example, Patent Literature 1 discloses technology for controlling a fixed position of a sound image of the sound of reproduced content in response to detection of utterance of a headphone wearer.

### CITATION LIST

### Patent Literature

Patent Literature 1: JP 2011-97268 A

### SUMMARY

### Technical Problem

It is conceivable to apply technology, for controlling sound reproduction in response to utterance, to a hearing aid device. In order to reduce listening fatigue, hearing aid devices are often used usually with hearing aid processing turned off, and the hearing aid processing is turned on during conversation or the like. In this case, another person approaches a user of a hearing aid device to address the user, and the user of the hearing aid device turns on the hearing aid processing of the hearing aid device in response to the addressing, and then a conversation starts. There is room for study on technology for enabling a smoother conversation start.

One aspect of the present disclosure enables both reduction of listening fatigue and smooth conversation start.

### Solution to Problem

An information processing system according to one aspect of the present disclosure includes: a plurality of devices participating in a local communication network, wherein the plurality of devices comprises: a first device used by a first user, the first device functioning as a detection device that detects utterance of the first user; and a second device used by a second user, the second device functioning as a hearing aid device that executes hearing aid processing, the first device transmits an utterance flag indicating presence or absence of utterance to the second device, and the second device turns on the hearing aid processing in a case where the utterance flag indicates presence of utterance.

A device according to one aspect of the present disclosure a device that participates in a local communication network together with another device and executes hearing aid processing, wherein the device turns on the hearing aid processing in a case where an utterance flag indicating presence or absence of utterance transmitted by the other device indicates presence of utterance.

A device according to one aspect of the present disclosure is a device that participates in a local communication network together with another device and detects utterance of a user, wherein the device transmits an utterance flag indicating presence or absence of utterance to the other device.

An information processing method according to one aspect of the present disclosure is an information processing method performed by a plurality of devices participating in a local communication network, the plurality of devices comprising: a first device used by a first user, the first device functioning as a detection device that detects utterance of the first user; and a second device used by a second user, the second device functioning as a hearing aid device that executes hearing aid processing, the information processing method comprising the steps of: by the first device, transmitting an utterance flag indicating presence or absence of utterance to the second device, and by the second device, turning on the hearing aid processing in a case where the utterance flag indicates presence of utterance.

A program according to one aspect of the present disclosure is a program for causing a computer to function as a plurality of devices participating in a local communication network, wherein the plurality of devices includes: a first device used by a first user, the first device functioning as a detection device that detects utterance of the first user; and a second device used by a second user, the second device functioning as a hearing aid device that executes hearing aid processing for assisting hearing aid of the second user, the first device transmits an utterance flag indicating presence or absence of utterance to the second device, and the second device turns on the hearing aid processing in a case where the utterance flag indicates presence of utterance.

### BRIEF DESCRIPTION OF DRAWINGS

FIG. 1 is a diagram illustrating an exemplary schematic configuration of an information processing system according to an embodiment.

FIG. 2 is a flowchart illustrating an example of processing (information processing method) executed in the information processing system.

FIG. 3 is a diagram illustrating exemplary use cases.

FIG. 4 is a diagram illustrating an example of a schematic configuration of the information processing system.

FIG. 5 is a diagram illustrating an example of a management device.

FIG. 6 is a diagram illustrating an example of a relay device.

FIG. 7 is a diagram illustrating an example of a relay device.

FIG. 8 is a diagram illustrating an example of ON transition of hearing aid processing.

FIG. 9 is a diagram illustrating an example of the hearing aid processing based on a speaker feature amount.

FIG. 10 is a diagram illustrating an example of a schematic configuration of the information processing system.

FIG. 11 is a diagram illustrating an example of a schematic configuration of the information processing system.

FIG. 12 is a flowchart illustrating an example of processing (information processing method) executed in the information processing system.

FIG. 13 is a diagram illustrating an example of a schematic configuration of the information processing system.

FIG. 14 is a diagram illustrating an example of a schematic configuration of a mixer.

FIG. 15 is a diagram illustrating a schematic configuration of a hearing aid system.

FIG. 16 is a block diagram illustrating a functional configuration of the hearing aid system.

FIG. 17 is a diagram illustrating examples of utilization of data.

FIG. 18 is a table illustrating an example of data.

FIG. 19 is a diagram illustrating an example of cooperation with other devices.

FIG. 20 is a diagram illustrating an example of application transition.

### DESCRIPTION OF EMBODIMENTS

Hereinafter, embodiments of the present disclosure will be described in detail on the basis of the drawings. Note that in each of the following embodiments, the same elements are denoted by the same symbols, and redundant description will be omitted.

The present disclosure will be described in the following order of items.
0. Introduction
1. Embodiments
2. Exemplary Use Cases
3. Modifications
   3.1. Detection Device and Hearing Aid Device
   3.2. Plurality of First Devices and Plurality of Second Devices
   3.3. Management Device
   3.4. Relay Device
   3.5. ON Transition of Hearing Aid Processing
   3.6. Hearing Aid Processing Based On Speaker Feature Amount
   3.7. Forced ON and OFF Control of Device Function
   3.8. Adjustment of Hearing Aid Sound and Other Sound
4. Example of Hearing Aid System
5. Example of Data Utilization
6. Example of Cooperation with Other Devices
7. Example of Application Transition
8. Exemplary Effects

### 0. Introduction

There are increasing expectations for improvement in quality of life (QoL) through auditory devices with a demand for spread of solutions for hearing difficulties driven mainly by hearing aid devices such as hearing aids and sound collectors. In the home or in a community, although it is desired to correctly hear surrounding voices, if with hearing aid processing always turned on (operational state), other types of sound are also amplified, which causes listening fatigue. Some people give up wearing hearing aid devices and may not benefit from hearing correction.

To reduce listening fatigue, it is also conceivable to turn on the hearing aid processing of the hearing aid device only at the time of an intended conversation. However, in this case, for people around the user, the conversation experience with the user of the hearing aid device is different from the conversation experience with normal hearing persons. In the case of normal hearing persons, a conversation is smoothly started even from a slightly distant place. Meanwhile, in order to start a conversation with the user of the hearing aid device, it takes efforts for the normal hearing person to come close to the user of the hearing aid device, to tap on the shoulder, or to catch the eyes to make the user notice his/her call to turn on the hearing aid processing of the hearing aid device.

In recent years, the idea of being barrier free or being inclusive has been permeating, and the number of people who do as the above without hesitating at all is increasing. However, it is also conceivable that, as the conversation frequently takes place, the accumulation of efforts may affect consciously or subconsciously, which may hinder preferable communication. Even in a case where the person around does not care, there is a possibility that the user of the hearing aid device himself/herself feels bothered that the user is causing the person around a trouble taking special care or causing a trouble.

Therefore, there is a demand for technology that implements both “introduction to a smooth conversation equivalent to a conversation experience between normal hearing persons” and “reduction of listening fatigue by constant use of hearing aid processing”.

The disclosed technology may include, for example, the following features.

A (simple) network protocol for users to communicate between different devices.

A device used by a first user detects utterance of the first user and transmits information related to the utterance to a hearing aid device used by a second user. The information transmitted may be a small amount of data for controlling the hearing aid device rather than audio streaming.

The hearing aid device controls ON and OFF of hearing aid processing such that the second user can hear the utterance of the first user in accordance with the received information.

In the above, by reducing the amount of information to be transmitted, problems that may occur as the following can also be addressed for example in a case where audio streaming is transmitted. That is, when audio streaming is transmitted, there is a possibility that an unintended utterance from the first user is heard by the second user. By not transmitting audio streaming, such problems are eliminated, and privacy protection and the like are achieved. Furthermore, there is a case where the first user utters without having an intention to talk to the second user, and in this case, transmitting audio streaming is annoying to the second user.

Although it is conceivable to allow the first user to select necessity of audio streaming transmission in the device used by the first user, there is a problem that the trouble of selecting operation or the like hinders smooth conversation. Although it is conceivable that the device automatically determines whether or not the audio streaming transmission is necessary, the determination of the presence or absence of the intention of the first user to talk is an issue of estimating the intention of the user, and it is difficult to increase the accuracy of the determination, which may not be sufficient as a countermeasure.

### 1. Embodiments

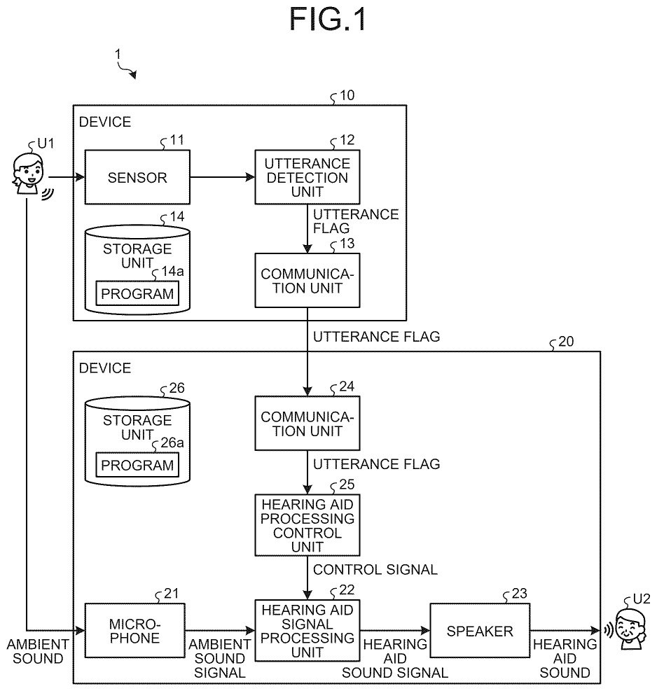

FIG. 1 is a diagram illustrating an exemplary schematic configuration of an information processing system according to an embodiment. An information processing system 1 includes a plurality of devices. The plurality of devices includes a first device and a second device. Exemplified in FIG. 1 are one device 10 and another device 20 as the first device and the second device, respectively. The device 10 is used by a user U1, who is an example of a first user. The device 20 is used by a user U2, who is an example of a second user. The device 10 and the device 20 may be portable devices and are charged by, for example, a charging device (not illustrated) or the like.

The device 10 and the device 20 participate in a local communication network. The local communication network is configured by the device 10 and the device 20 establishing a communication connection with each other such that at least data transmission from the device 10 to the device 20 can be performed. The communication means is not particularly limited. For example, near-field communication may be used. Examples of the near-field communication include Bluetooth (registered trademark) (BT) communication, wireless LAN communication, and the like. In the case of BT, the devices may directly perform data communication using a serial port profile (SPP). The local communication network is, for example, a communication network for a community in which the user U1 and the user U2 participate. Examples of the community include a family community, a friend community, and the like.

The device 10 functions as a detection device that detects utterance of the user U1. The device 10 is disposed near the user U1 or worn by the user U1. An example of where to wear is the head of the user U1, more specifically, the ear of the user U1 or the vicinity thereof, and utterance of the user U1 can be easily detected by being worn on the ear or the vicinity thereof. The device 10 may be a portable device, and in this case, the device 10 may be charged by a charging device (not illustrated) or the like. FIG. 1 also illustrates functional blocks of the device 10. The device 10 includes a sensor 11, an utterance detection unit 12, a communication unit 13, and a storage unit 14.

The sensor 11 is used to detect utterance of the user U1. A typical example of the sensor 11 is a microphone, and in this case, the sensor 11 detects (collects) utterance sound of the user U1. Another example of the sensor 11 is an acceleration sensor, in which case the sensor 11 detects the acceleration caused by an utterance action of the user U1. A sensor other than the above may also be used as the sensor 11. Such a sensor may be, for example, a biological sensor or the like for detecting (collecting) utterance sound of the user U1. Furthermore, the sensor 11 may be, for example, a camera. The motion of the mouth of the user U1 may be recognized by the camera to detect utterance. The sensor 11 may be a combination of a plurality of sensors, and the types of the plurality of sensors in this case may be the same or different.

The utterance detection unit 12 detects utterance of the user U1 on the basis of the detection result of the sensor 11. Detection of the utterance may be detection of presence or absence of the utterance. For example, the method described in Patent Literature 1 may be used. Describing some examples, in a case where the sensor 11 includes a microphone, it may be detected that there is utterance in a case where the signal level of a microphone signal is greater than or equal to a threshold value. In a case where the sensor 11 includes an acceleration sensor, for example, it may be detected that there is utterance when a motion of the user U1 that may occur with utterance is detected. Examples of such a motion is a motion of the face or the like of the user U1 searching for the user U2 or facing toward the user U2, specifically, a motion of swinging the face left and right, a motion of swinging the face up and down, and the like.

The utterance detection unit 12 generates an utterance flag indicating the presence or absence of utterance. In the device 10 used by the user U1, an utterance flag indicating the presence of utterance is generated when utterance of the user U1 is detected. The utterance flag does not include audio streaming data, and thus the data size of the utterance flag can be much smaller than the data size of audio streaming.

In one embodiment, an utterance flag may include bit data indicating the presence or absence of utterance. The bit data may be 1-bit data, and the utterance flag in this case indicates the presence or absence of utterance with “0” or “1”. For example, the utterance flag of “0” indicates absence of utterance, and the utterance flag of “1” indicates presence of utterance.

The communication unit 13 communicates with another device, in this example, the device 20. The communication unit 13 transmits the utterance flag generated by the utterance detection unit 12 to the device 10.

Note that the generation of the utterance flag by the utterance detection unit 12 may be performed only when utterance of the user U1 is detected, or may be performed at regular intervals. An example of the regular interval is several tens of milliseconds (for example, 50 milliseconds or the like). Similarly, the transmission of the utterance flag by the communication unit 13 may be performed only when utterance of the user U1 is detected or may be performed at regular intervals.

The storage unit 14 stores information used in the device 10. Examples of the information stored in the storage unit 14 include a program 14a. The program 14a is, for example, an information processing program (software) for causing a computer to function as the device 10.

The device 20 functions as a hearing aid device that executes hearing aid processing such as a hearing aid or a sound collector. The device 20 is disposed near the user U2 or worn by the user U2. An example of where to wear is the head of the user U2, more specifically, the ear of the user U2 or the vicinity thereof. The device 20 may be a portable device, and in this case, the device 20 may be charged by a charging device (not illustrated) or the like. FIG. 1 also illustrates functional blocks of the device 20. The device 20 includes a microphone 21, a hearing aid signal processing unit 22, a speaker 23, a communication unit 24, a hearing aid processing control unit 25, and a storage unit 26.

The microphone 21 detects ambient sound of the device 20 and generates a corresponding signal. This signal is referred to as an ambient sound signal. The ambient sound signal may include utterance sound of the user U1. The ambient sound signal generated by the microphone 21 is transmitted to the hearing aid signal processing unit 22.

The hearing aid signal processing unit 22 executes hearing aid processing. The hearing aid processing includes generation of a hearing aid sound signal based on the ambient sound signal. The hearing aid sound signal is, for example, a signal for providing sound adjusted such that the user U2 can easily hear the ambient sound. Various types of known hearing aid signal processing in the technical field of hearing aid may be used.

The hearing aid processing by the hearing aid signal processing unit 22 can be switched at any timing between ON, which is a state in which the hearing aid processing is operational (being executed), and OFF, which is a state in which the hearing aid processing is not operational (halted). The switching may be performed by a user operation. In the present embodiment, the switching is performed by the hearing aid processing control unit 25 as described later. The hearing aid sound signal generated by the hearing aid signal processing unit 22 is transmitted to the speaker 23.

The speaker 23 outputs sound corresponding to the hearing aid sound signal to the user U2. This output sound is referred to as hearing aid sound in the illustration, As a result, the user U2 can easily hear the ambient sound as compared with the case of directly hearing the ambient sound.

The communication unit 24 communicates with another device, in this example, the device 10. The communication unit 24 receives the utterance flag transmitted by the communication unit 13 of the device 10.

The hearing aid processing control unit 25 controls the hearing aid signal processing unit 22 on the basis of the utterance flag received by the communication unit 24. The control includes switching between ON and OFF of the hearing aid processing by the hearing aid signal processing unit 22. Specifically, in a case where the utterance flag indicates the presence of utterance, the hearing aid processing control unit 25 controls the hearing aid signal processing unit 22 such that the hearing aid processing is turned on. Conversely, in a case where the utterance flag indicates the absence of utterance, the hearing aid processing control unit 25 controls the hearing aid signal processing unit 22 such that the hearing aid processing is turned off.

In the example illustrated in FIG. 1, the hearing aid processing control unit 25 controls the hearing aid signal processing unit 22 by transmitting a control signal to the hearing aid signal processing unit 22. The control signal is, for example, a signal instructing ON or OFF of the hearing aid processing.

The storage unit 26 stores information used by the device 20. Examples of the information stored in the storage unit 26 include a program 26a. The program 26a is, for example, an information processing program (software) for causing a computer to function as the device 20.

In the present disclosure, functions such as detection of utterance of the user U1 and transmission of an utterance flag in the device 10 as described above are also simply referred to as functions of the device 10. A state in which these functions are enabled is also referred to as that the functions of the device 10 are turned on. The state otherwise is also referred to as that the functions of the device 10 are turned off. Furthermore, functions such as reception of an utterance flag and control of ON and OFF of the hearing aid processing based on the utterance flag in the device 20 as described above are also simply referred to as functions of the device 20. A state in which these functions are enabled is also referred to as that the functions of the device 20 are turned on. The state otherwise is also referred to as that the functions of the device 20 are turned off. The ON and OFF of the functions of the device 10 and the ON and OFF of the functions of the device 20 may be performed by a user operation or may be automatically performed as described later.

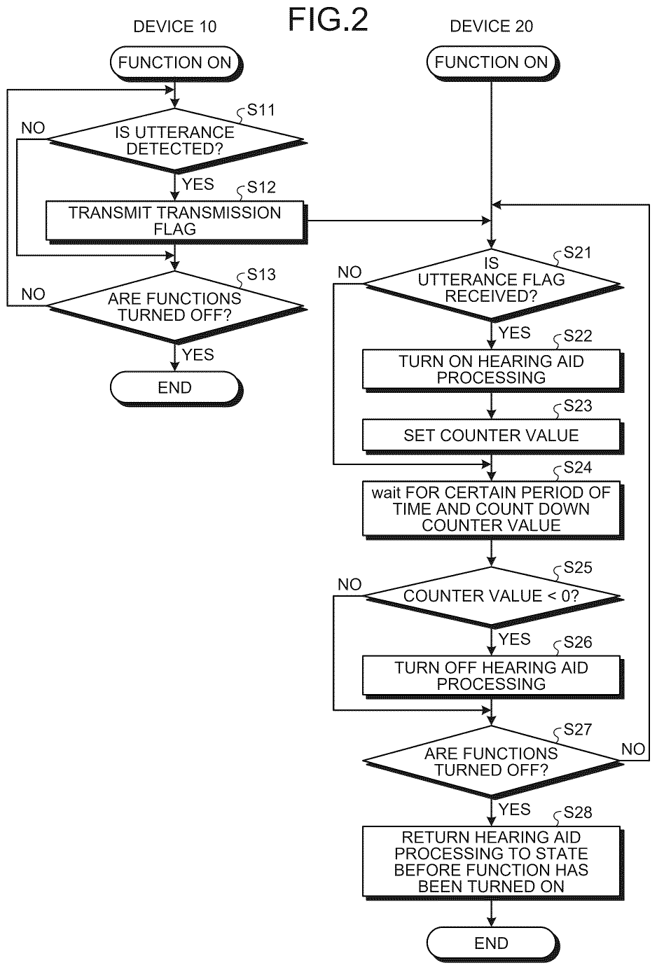

FIG. 2 is a flowchart illustrating an example of processing (information processing method) executed in the information processing system.

Processing of Steps S11 to S13 is executed in the device 10 when the functions of the device 10 are turned on. In this example, the device 10 transmits an utterance flag when utterance of the user U1 is detected.

In Step S11, it is determined whether or not utterance has been detected. The utterance here is utterance of the user U1. When the user U1 utters, the utterance detection unit 12 of the device 10 detects the utterance of the user U1 on the basis of a detection result of the sensor 11. If the utterance is detected (Step S11: Yes), the processing proceeds to Step S12. If not (Step S11: No), the processing proceeds to Step S13.

In Step S12, an utterance flag is transmitted. The utterance detection unit 12 of the device 10 generates the utterance flag indicating the presence of utterance. The communication unit 13 transmits the utterance flag to the device 20.

In Step S13, it is determined whether or not the functions are turned off. When the function of the device 10 is turned off (Step S13: Yes), the processing of the flowchart by the device 10 ends. If not (Step S13; No), the processing returns to Step S11.

By repeatedly executing the processing of Steps S11 to S13, the utterance flag indicating the presence or absence of utterance is transmitted from the device 10 to the device 20.

Note that, as described above, the device 10 may transmit the utterance flag to the device 20 at regular intervals. In this case, if no utterance is detected in Step S11 (Step S11: No), the device 10 generates an utterance flag indicating absence of utterance and transmits the utterance flag to the device 20. The processing of Steps S11 to S13 including such processing is repeatedly executed at regular intervals.

Processing of Steps S21 to S28 is executed in the device 20 when the functions of the device 20 are turned on.

In Step S21, it is determined whether or not an utterance flag has been received. In a case where the device 10 has transmitted an utterance flag to the device 20, the communication unit 24 of the device 20 receives the utterance flag. If the utterance flag is received (Step S21: Yes), the processing proceeds to Step S22. If not (Step S21: No), the processing proceeds to Step S24.

In Step S22, the hearing aid processing is turned on. The hearing aid processing control unit 25 of the device 20 controls the hearing aid signal processing unit 22 such that the hearing aid processing is turned on.

In Step S23, a counter value is set. This processing is executed, for example, by the hearing aid processing control unit 25 of the device 20. The hearing aid processing control unit 25 sets a counter value having a given positive value. For example, a counter value requiring a count time of about several seconds is set. Note that in a case where there is already a counter value, the counter value is overwritten.

In Step S24, after waiting for a certain period of time, the count value is counted down. This processing is executed, for example, by the hearing aid processing control unit 25 of the device 20.

In Step S25, it is determined whether or not the counter value is less than 0. If the counter value is less than 0 (Step S25: Yes), the processing proceeds to Step S26. If not (Step S25: No), the processing proceeds to Step S27.

In Step S26, the hearing aid processing is turned off. The hearing aid processing control unit 25 of the device 20 controls the hearing aid signal processing unit 22 such that the hearing aid processing is turned off.

In Step S27, it is determined whether or not the functions are turned off. If the functions of the device 20 are turned off (Step S27: Yes), the processing proceeds to Step S28. If not (Step S27: No), the processing returns to Step S21.

In Step S28, the hearing aid processing is returned to the state before the functions were turned on. For example, the hearing aid processing control unit 25 of the device 20 controls the hearing aid signal processing unit 22 such that the content such as settings of the hearing aid processing is in a state before the processing of the flowchart by the device 20 were started. As a result, the user U2 can use the device 20 in the original state. After the processing of Step S28 is completed, the processing of the flowchart by the device 20 ends.

By repeatedly executing the processing of Steps S21 to S27, the hearing aid processing of the device 20 is turned on only when the utterance flag indicates the presence of utterance.

According to the information processing system 1 described above, only when the user U1 of the device 10 makes utterance, the utterance flag indicating the presence of utterance is transmitted from the device 10 to the device 20, and the hearing aid processing of the device 20 is turned on. This makes it possible to reduce the listening fatigue of the user U2 due to, for example, the hearing aid processing being constantly ON. The utterance of the user U1 can be, for example, address by the user U2 for starting a conversation with the user U2. Since the hearing aid processing of the device 20 is automatically turned on in response to such utterance of the user U1, the user U2 can smoothly start a conversation with the user U1 while using the device 20 as the hearing aid device. Therefore, it is possible to achieve both reduction of listening fatigue and smooth conversation start.

### 2. Exemplary Use Cases

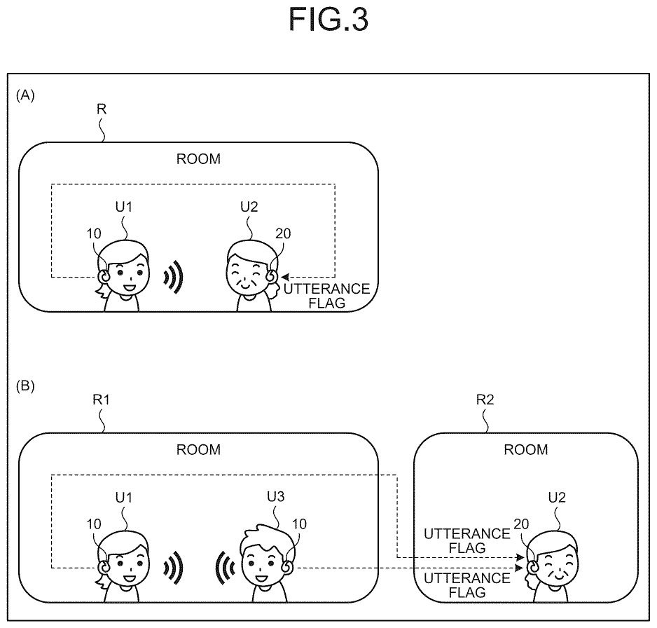

FIG. 3 is a diagram illustrating exemplary use cases. In this example, the device 10 and the device 20 are worn on the ears of the user U1 and the device 20, respectively.

In an example illustrated in (A) of FIG. 3, the user U1 and the user U2 are having a conversation in a room R. When the user U1 utters, the device 10 transmits an utterance flag to the device 20, and the hearing aid processing of the device 20 is turned on. The user U1 and the user U2 can smoothly start a conversation.

In an example illustrated in (B) of FIG. 3, the user U1 and a user U3 are having a conversation in a room R1. The user U3 is an example of the first user and uses the device 10 similarly to the user U1. The user U2 stays in a room R2 that is different from the room R1. When the user U1 and the user U3 have a conversation, the device 10 of the user U1 or a device 10 of the user U3 transmits an utterance flag to the device 20, and the hearing aid processing of the device 20 is turned on.

In this example, if the user U1 and the user U3 are having a conversation at a normal volume, the conversation sound is hardly included in the ambient sound detected by the microphone 21 of the device 20. Therefore, even when the hearing aid processing of the device 20 is ON, the conversation between the user U1 and the user U3 is hardly heard by the user U2. Incidentally, even if the hearing aid processing of the device 20 is ON, if the surroundings are quiet, the user U2 rarely feels discomfort.

If the user U1 and the user U3 are talking with small voice, the user U2 does not hear the conversation sound at all. In addition, since the device 10 worn by the user U1 and the user U3 merely transmits the utterance flag, which is extremely small amount of data and not the audio streaming, to the device 20 worn by the user U2, the conversation between the user U1 and the user U3 is not transmitted to the user U2, whereby privacy is also protected. Conversely, if the user U1 and the user U3 speak so loudly as to reach the room R2, the user U2 can hear the voice. Therefore, it is also possible to address the user U2. Meanwhile, in a case where the user U1 (or the user U3) and the user U2 stay in different rooms, it is also conceivable that the user U1 (or the user U3) is in an environment where the user U1 (or the user U3) is hesitated to speak to the user U2 loudly (such as in the midnight time) or that it is troublesome or difficult to physically go to talk to the user U2 (for example, in a case where the user U1 (or the user U3) stays on the first floor and the user U2 stays on the second floor, and the user U1 for the user U3) has trouble walking and it is difficult to physically go to talk to the user U2). In such a case, audio streaming may be transmitted in addition to an utterance flag. Whether to send only the utterance flag to the user U2 or to send also the audio streaming in addition to the utterance flag may be determined on the basis of the conversation content between the user U1 and the user U3 or user information or may be set by the user as appropriate. This may be determined on depending on the positional relationship between the user U1 (or the user U3) and the user U2 (for example, in a case where the user U1 (or the user U3) and the user U2 are in the same room, only the utterance flag is transmitted, and in a case where the user U1 (or the user U3) and the user U2 are in different rooms, audio streaming is transmitted in addition to the utterance flag). Furthermore, for example, in a case where the user U2 is listening to content such as music or radio sound in a noise canceling mode via the device 20, transition from the noise canceling mode to an external sound capturing mode may be performed, triggered by transmission of an utterance flag. In this manner, the user U2 can clearly listen to address from the user U1 (or the user U3) while enjoying the content.

### 3. Modifications

The technology disclosed is not limited to the above embodiments. Some modifications will be described.

### 3.1. Detection Device and Hearing Aid Device

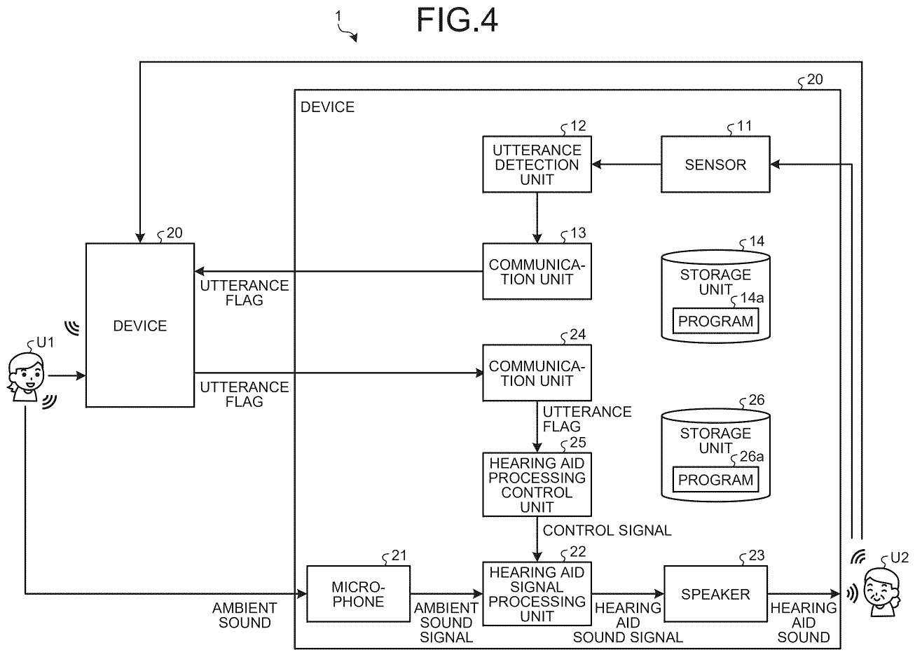

In one embodiment, at least one of the device 10 or the device 20 may function as both a detection device and a hearing aid device. This will be described with reference to FIG. 4.

FIG. 4 is a diagram illustrating an example of a schematic configuration of an information processing system. In this example, a device 20 also functions as a detection device. The device 20 can be used in place of the device 10 described above. In the example illustrated in FIG. 4, both the user U1 and the user U2 use the device 20. Since the functional blocks of the device 20 can be described as a combination of the functional blocks of the device 10 and those of the device 20 described above with reference to FIG. 1, the description thereof is omitted, Note that both the user U1 and the user U2 may use the device 10. In this case, the device 10 has both a music reproduction function such as that of an earphone or a headphone and a hearing aid function such as that of a hearing aid or a sound collector.

Note that, in a case where the sensor 11 includes a microphone, the microphone of the sensor 11 may be used instead of the microphone 21. In this case, the microphone 21 may be omitted. In a case where the sensor 11 only requires a microphone, the microphone 21 may be used instead of the sensor 11. In this case, the sensor 11 may be omitted. Furthermore, the communication unit 13 and the communication unit 24 may be implemented by one communication unit. Similarly, the storage unit 14 and the storage unit 26 may be implemented by one storage unit.

Similarly, the program 14a and the program 26a may be implemented by one program.

In a case where the device 10 functions as a hearing aid device, the device 10 may have a configuration similar to that of the device 20 illustrated in FIG. 4. Both the user U1 and the user U2 may use the device 10.

Note that, in the above case, the user U1 may use the device 20, and the user U2 may use the device 10. However, for ease of understanding, unless otherwise specified, the following description is given on the basis of the premise that the user U1 uses the device 10 and the user U2 uses the device 20.

### 3.2. Plurality of First Devices and Plurality of Second Devices

A plurality of first devices (plurality of the devices 10), each of which used by a different first user, may participate in a local communication network. In addition, a plurality of second devices (plurality of the devices 20), each of which used by a different second user, may participate in the local communication network. It is possible to achieve a smooth conversation start among many users.

### 3.3. Management Device

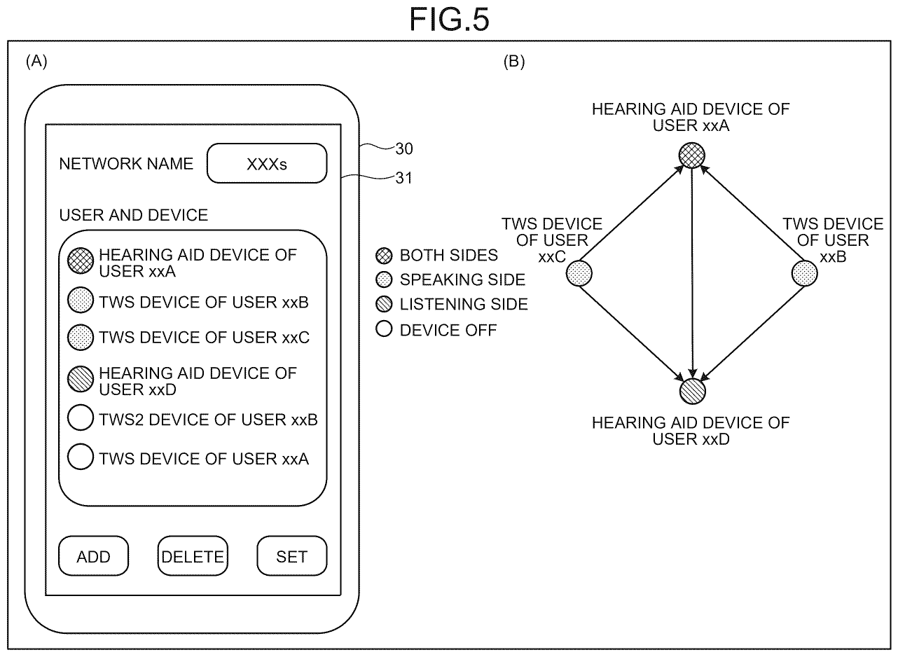

In one embodiment, the information processing system 1 may include a management device that manages the local communication network. This will be described with reference to FIG. 5.

FIG. 5 is a diagram illustrating an example of the management device. The management device 30 illustrated in FIG. 5 (A) is, for example, a smartphone and displays a management screen for managing the local communication network. The management device 30 includes a user interface unit 31 (for example, a display unit) that presents information to the user and accepts a user operation.

The management screen displays information such as the name of the local communication network, users, and devices to be managed. The name of the local communication network is schematically indicated as a network name of “XXXs”. Users (participating members) and devices participating in the local communication network are displayed in a mode that can be selected, added, deleted, or the like. The users are schematically illustrated as a user xxA, a user xxB, a user xxC, and a user xxD. The devices are illustrated, for example, as a hearing aid device or a true wireless stereo (TWS) device.

The settings of each device, namely, the speaking side, the listening side, or both sides described above, are schematically indicated by differently hatched circles. Note that a device in a state in which communication cannot be performed due to power off of the device or the like is schematically indicated by a hollow circle as device off. In addition to these, for example, the state or the schedule of the user, the remaining battery level of each device, or others may be displayed together. The state of the user is, for example, data indicating the capacity of hearing or hearing difficulties of the user. In the case of a user whose hearing difficulties has progressed, it is conceivable that daily life is disturbed unless the user always wears a hearing aid device such as a hearing aid or a sound collector. In the case of such a user, it is necessary to frequently check the charging status of the hearing aid device and to always use an appropriate hearing aid device depending on one's own capability of hearing. Therefore, by displaying these pieces of data together, not only the hearing aid device user himself/herself but also other members (for example, family members) participating in the local communication network can more easily support the user.

Note that, for example, Bluetooth LE Audio (registered trademark), near field magnetic induction (NFMI), near field communication (NFC), or LDAC (registered trademark), or the like may be used as the local communication network other than BT and Wi-Fi described above, or a communication protocol other than these may be used.

In the management screen of the example, it is possible to add, delete, and set a device to participate in the local communication network. The addition and deletion are as described above. The setting includes a setting of a role of the device in the local communication network. For example, each device is set to one of a device on the speaking side, a device on the listening side, or a device on both sides thereof. The device on the speaking side is used as a detection device and is, for example, the device 10 described above with reference to FIG. 1. The device on the listening side is used as a hearing aid device and is, for example, the device 20 described above with reference to FIG. 1. The device on both sides is used as a detection device and as a hearing aid device and is, for example, the device 20 described above with reference to FIG. 4 or the device 10 having a configuration similar thereto.

(B) of FIG. 5 schematically illustrates a relationship of transmission and reception of an utterance flag among devices in accordance with the setting. An arrow indicates transmission of an utterance flag. The hearing aid device of the user xxA transmits an utterance flag to the hearing aid device of the user xxD. The TWS device of the user xxB and the TWS device of the user xxC transmit an utterance flag to the hearing aid device of the user xxA and the hearing aid device of the user xxD.

For example, by using the management device 30 as described above, complicated setting of one or more local communication networks in which many devices may participate can be easily performed. In addition, since it is not necessary to provide the devices with a management function, a security function, and the like of the local communication network, the configuration (for example, software configuration) of the devices can be simplified accordingly.

Note that the management device 30 is not limited to a smartphone. Other examples of the management device 30 include a smart watch, a charging device, and the like. Incidentally, management by the management device 30 as described above is not essential. For example, in simple cases where there are only two devices participating in the local communication network or positions of all the devices are fixed, management by the management device 30 is not necessary. In that case, for example, a local communication network may be configured and device setting may be performed by operation of a button or the like included in the device body, the charging device, or others. Network configuration can also be performed by an operation as if BT pairing is performed.

### 3.4. Relay Device

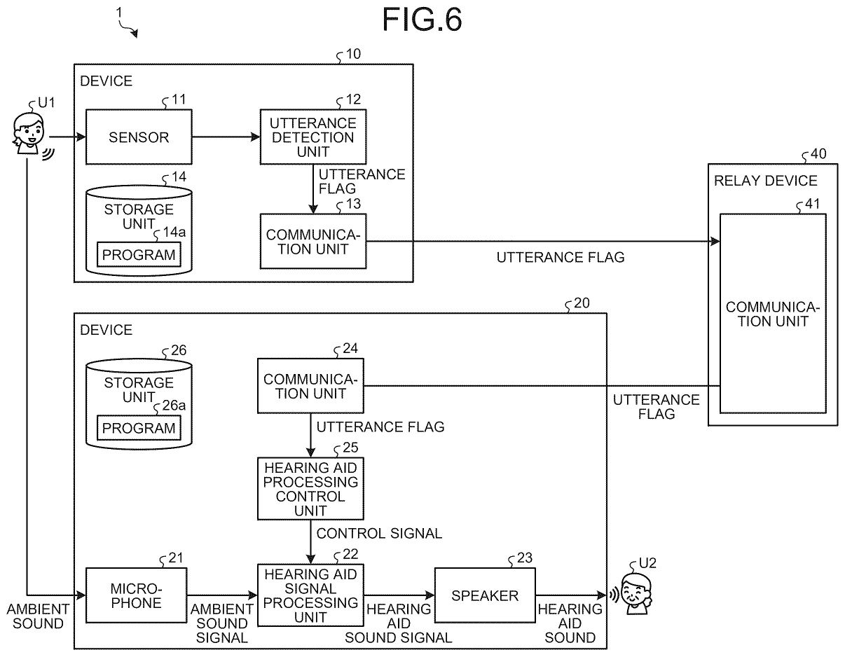

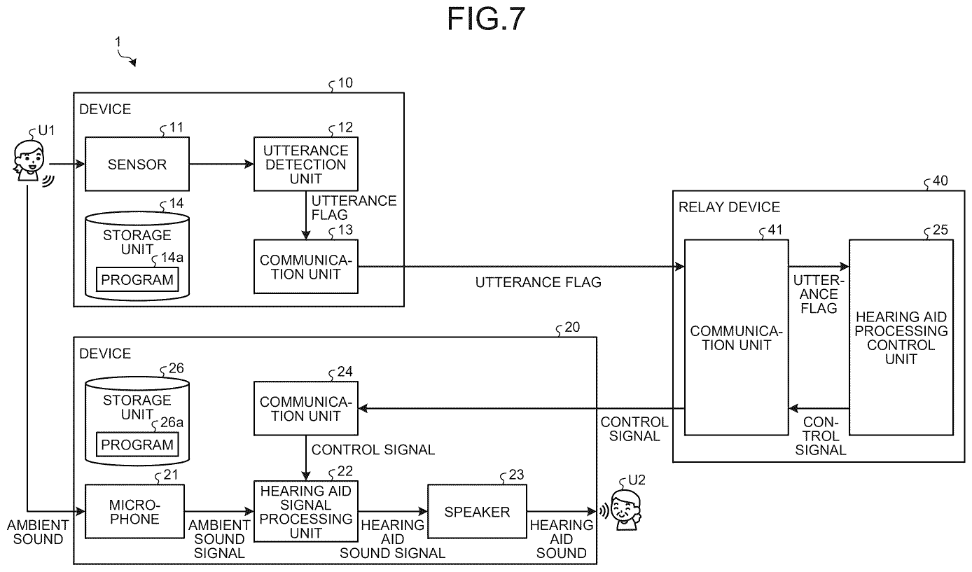

In one embodiment, the information processing system 1 may include a relay device that relays communication between devices. This will be described with reference to FIGS. 6 and 7.

FIG. 6 is a diagram illustrating an example of the relay device. The information processing system 1 includes a relay device 40. The relay device 40 is, for example, a smartphone or the like used by the user U2 and relays communication between the device 10 and the device 20. A cloud or a server may serve as the relay device. In the example illustrated in FIG. 6, the relay device 40 includes a communication unit 41. The communication unit 41 communicates with other devices, in this example, the device 10 and the device 20. The communication unit 41 receives an utterance flag transmitted by the device 10 and transmits the received utterance flag to the device 20.

In one embodiment, some functions of the device 10 or the device 20 may be included in the relay device 40. This will be described with reference to FIG. 7.

FIG. 7 is a diagram illustrating an example of the relay device. In this example, not the device 20 but the relay device 40 has the function of the hearing aid processing control unit 25. In the relay device 40, the hearing aid processing control unit 25 generates a control signal on the basis of an utterance flag received by the communication unit 41. The communication unit 41 transmits a control signal to the device 20.

Without being limited to the hearing aid processing control unit 25, some of the functions of the device 10 or the device 20 may be included in the relay device 40. Accordingly, the functions of the device 10 and the device 20 can be simplified.

### 3.5. ON Transition of Hearing Aid Processing

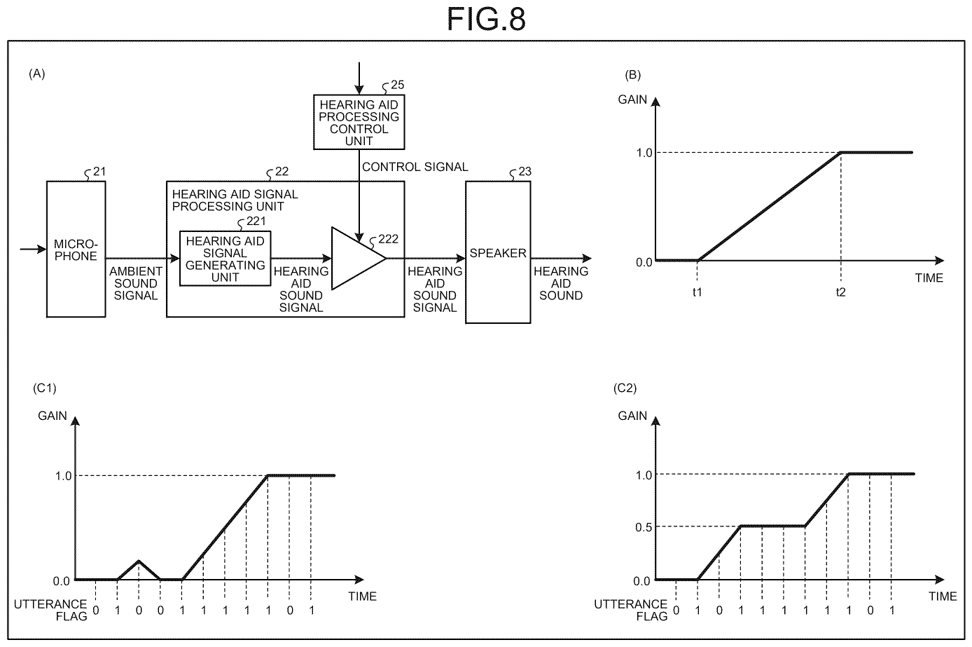

In an embodiment, turning on the hearing aid processing may include gradually increasing the signal level of the hearing aid sound signal generated by the hearing aid processing. This makes it possible to smoothly change the volume of the output hearing aid sound. It is possible to cope with a problem that the user U2 feels uncomfortable with an abruptly increased volume. This will be described with reference to FIG. 8.

FIG. 8 is a diagram illustrating an example of ON transition of the hearing aid processing. (A) of FIG. 8 illustrates an example of a configuration of the hearing aid signal processing unit 22 and its periphery. The hearing aid signal processing unit 22 includes a hearing aid signal generating unit 221 and a level adjuster 222. The hearing aid signal generating unit 221 generates a hearing aid sound signal. The level adjuster 222 adjusts the signal level of the hearing aid sound signal generated by the hearing aid signal generating unit 221. In this example, the level adjuster 222 is a variable gain amplifier and, in this example, it is based on the premise that the gain can be controlled in a range between 0 and 1. Control of the hearing aid signal processing unit 22 by the hearing aid processing control unit 25 includes gain control of the level adjuster 222.

(B) of FIG. 8 illustrates an example of gain control in a case where only an utterance flag indicating the presence of utterance is transmitted from the device 10 to the device 20. The horizontal axis of the graph represents time, and the vertical axis represents the gain of the level adjuster 222.

Before time t1, the hearing aid processing is OFF, and the gain is 0. At time t1, an utterance flag indicating the presence of utterance is received, and a transition is made such that the gain gradually increases. At time t2, the gain reaches 1, and the hearing aid processing is turned on. The period from time t1 to time t2 corresponds to an ON transition period (transition period) of the hearing aid processing. The transition period may be desirably set and may be set to, for example, Several hundred milliseconds (for example, 200 milliseconds). Note that, in the example illustrated in (B) of FIG. 8, the gain changes linearly with time; however, control such that the gain changes logarithmically or control such that the gain changes non-linearly may be performed.

(C1) and (C2) of FIG. 8 illustrate examples of gain control in a case where an utterance flag indicating the presence or absence of utterance is transmitted from the device 10 to the device 20 at regular intervals. “0” or “1” indicated below the horizontal axis of the graphs indicate bit data of the utterance flag received at that time. In this example, an utterance flag of “0” indicates absence of utterance, and an utterance flag of “1” indicates presence of utterance.

In the example illustrated in (C1) of FIG. 8, every time an utterance flag “1” is received, the transition is performed such that the gain gradually increases. When an utterance flag “0” is received during the gain transition, the gain transitions such that the hearing aid processing is turned off, that is, the gain approaches 0.

In the example illustrated in (C2) of FIG. 8, the gain of the transition destination is controlled stepwise depending on the frequency of received utterance flag “0” and utterance flag “1”. The higher the frequency of the utterance flag “1” is, the higher the gain of the transition destination may be controlled to be. In this example, if all the utterance flags are “1” among three most recently received utterance flags, transition is made until the gain becomes 1. If it is twice or less, the gain transitions only up to 0.5.

Although not illustrated, in one embodiment, the utterance flag may indicate the probability of the presence or absence of utterance. In that case, turning on the hearing aid processing may include setting the signal level of the hearing aid sound signal generated by the hearing aid processing to a magnitude corresponding to the probability indicated by the utterance flag. For example, the gain of the level adjuster 222 may be controlled on the basis of the threshold determination with regard to the probability. As an example, in a case where the probability is represented as a range between 0 and 1, the gain may be controlled to be 0 in a case where the probability is less than or equal to 0.5, the gain may be controlled to be 0.5 in a case where the probability is less than or equal to 0.8, and the gain may be controlled to be 1 in a case where the probability is greater than 0.8. It is possible to control the volume of the hearing aid sound depending on the probability of the presence of absence of utterance. Furthermore, the power consumption of the device 20 can be suppressed by adjusting the signal level of the hearing aid sound signal on the basis of the probability of the presence or absence of utterance.

### 3.6. Hearing Aid Processing Based on Speaker Feature Amount

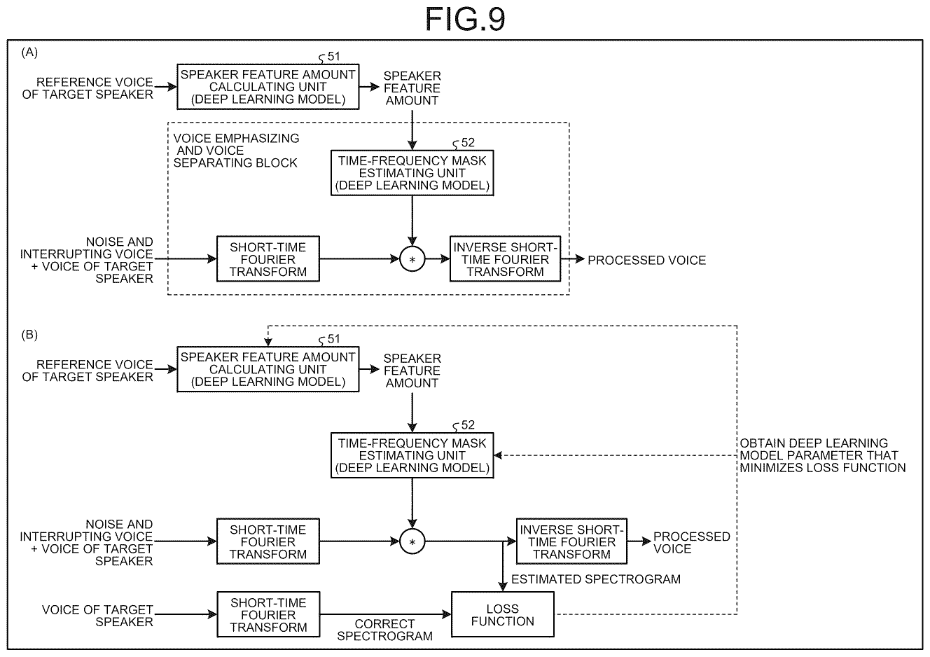

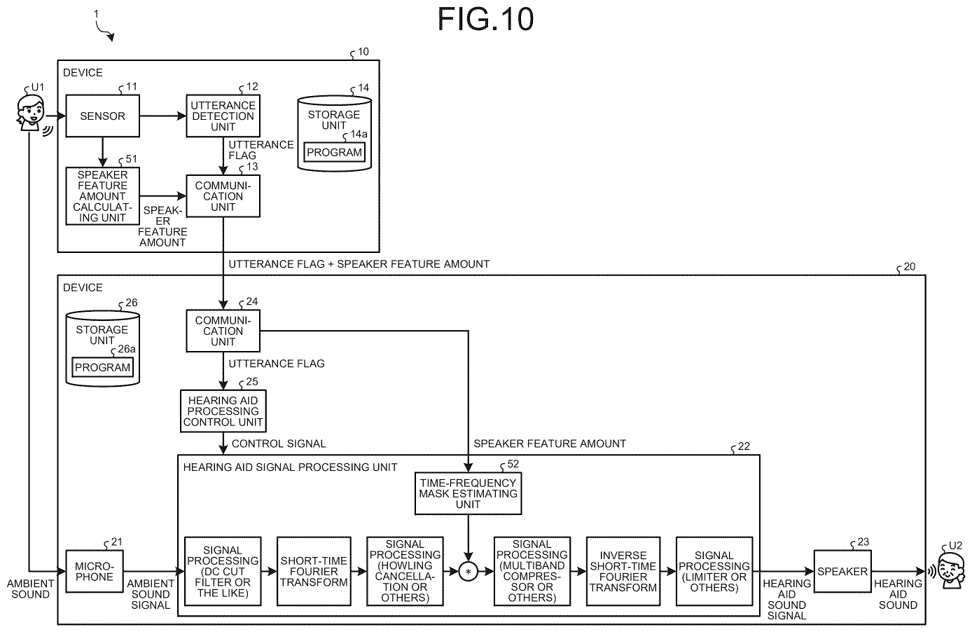

In an embodiment, the hearing aid processing in the device 20 may include generating a hearing aid sound signal on the basis of the speaker feature amount of the user U1. For example, under a low S/N environment in which the ratio of utterance sound of the user U1 in the ambient sound detected by the microphone 21 of the device 20 is low, it is possible to generate a hearing aid sound signal that emphasizes the voice of the user U1. This will be described with reference to FIGS. 9 and 10.

FIG. 9 is a diagram illustrating an example of the hearing aid processing based on the speaker feature amount. Two learned models (deep learning models) of a speaker feature amount calculating unit 51 and a time-frequency mask estimating unit 52 are used. The speaker feature amount calculating unit 51 calculates the speaker feature amount on the basis of reference voice of a target speaker. The time-frequency mask estimating unit 52 estimates, for example, a time-frequency mask that can efficiently extract the voice of the target speaker on the basis of the speaker feature amount calculated by the speaker feature amount calculating unit 51.

(A) of FIG. 9 schematically illustrates inference processing by the speaker feature amount calculating unit 51 and the time-frequency mask estimating unit 52. A signal of sound including not only the voice of the target speaker but also noise and interference voice is subjected to short-time Fourier transform. The signal after the short-time Fourier transform is, for example, filtered in accordance with the time-frequency mask estimated by the time-frequency mask estimating unit 52 and is subjected to inverse short-time Fourier transform. The signal after the inverse short-time Fourier transform is obtained as a signal of the processed voice.

(B) of FIG. 9 schematically illustrates learning processing of the speaker feature amount calculating unit 51 and the time-frequency mask estimating unit 52. The signal before the inverse short-time Fourier transform described above is used as an estimated spectrogram. Furthermore, a signal of sound including only the voice of the target speaker is subjected to short-time Fourier transform and is used as a correct spectrogram. A loss function based on the estimated spectrogram and the correct spectrogram is calculated. Parameters for the speaker feature amount calculating unit 51 and the time-frequency mask estimating unit 52 that minimize the loss function are obtained.

By using the speaker feature amount calculating unit 51 and the time-frequency mask estimating unit 52 as described above, for example, it is possible to perform the hearing aid processing based on the speaker feature amount. This will be described with reference to FIG. 10.

FIG. 10 is a diagram illustrating an example of a schematic configuration of an information processing system. A device 10 includes a speaker feature amount calculating unit 51. The speaker feature amount calculating unit 51 calculates the speaker feature amount of the user U1 from the utterance sound (voice) of the user U1 detected by the sensor 11. The communication unit 13 transmits the speaker feature amount calculated by the speaker feature amount calculating unit 51 to the device 20 together with an utterance flag generated by the utterance detection unit 12.

A communication unit 24 of a device 20 receives the utterance flag and the speaker feature amount transmitted by the device 10. A hearing aid signal processing unit 22 of the device 20 includes the time-frequency mask estimating unit 52. The time-frequency mask estimating unit 52 estimates a time-frequency mask on the basis of the speaker feature amount received by the communication unit 24. An ambient sound signal from a microphone 21 is subjected to signal processing by a DC cut filter or the like and then subjected to short-time Fourier transform. The signal after the short-time Fourier transform is subjected to signal processing such as howling cancellation, subjected to filtering or the like in accordance with the time-frequency mask estimated by the time-frequency mask estimating unit 52, subjected to signal processing by a multiband compressor or the like, and then subjected to inverse short-time Fourier transform. The signal after the inverse short-time Fourier transform is subjected to signal processing by a limiter or the like and is output as a hearing aid sound signal. The hearing aid sound signal is generated in such a manner to emphasize the utterance sound of the user U1 among the sounds included in the ambient sound, for example.

The above configuration is merely an example, and various other configurations may be adopted. For example, the utterance feature amount of the user U1 may be prepared in advance and stored in the storage unit 14 of the device 10. The device 10 transmits the utterance feature amount stored in the storage unit 14 together with the utterance flag. The device 10 may not include the speaker feature amount calculating unit 51. Furthermore, in the device 20, utterance feature amounts of other users (including the user U1) prepared in advance may be stored in the storage unit 26. In that case, transmission of the utterance feature amount from the device 10 to the device 20 is also unnecessary. Instead, the device 10 transmits information indicating that the speaker is the user U1 to the device 20 along with the utterance flag. The device 20 uses the speaker feature amount of the user U1 stored in the storage unit 26. Note that a learned model (deep learning model) is used for the speaker feature amount calculating unit 51 and the time-frequency mask estimating unit 52 described above, hence speaker feature amounts of a large number of users U1 calculated by speaker feature amount calculating units 51 of a large number of devices 10 may be uploaded to a cloud or a server, and the learning model used for the speaker feature amount calculating unit 51 and the time-frequency mask estimating unit 52 may be updated using these speaker feature amounts.

### 3.7. Forced ON and OFF Control of Device Function

In one embodiment, ON and OFF of the functions of the device 10 or the device 20 may be forcibly controlled. As described earlier, the functions of the device 10 include detection of utterance of the user U1, transmission of an utterance flag, and others. The functions of the device 20 include reception of an utterance flag, control of ON and OFF of the hearing aid processing, and others.

The information processing system 1 may include an external device that controls the device 10 and the device 20. The external device may be the management device 30 described above with reference to FIG. 5, and description is given here on the premise that the external device is the management device 30. In this case, the management device 30 manages whether the functions of each device participating in the local network communication is ON or OFF or manages whether the communication function of each device is ON or OFF.

As to ON and OFF of the communication function, for example, the management device 30 may treat a device having a high communication connection strength (a reception level of a communication signal or the like) as a device of which communication function is ON and may treat a device having a low communication connection strength as a device of which communication function is OFF. An example of the communication connection strength is the reception level of the communication signal. An example of the determination of the level of the communication connection strength is threshold determination or the like. Note that, in a case where the communication connection strength is extremely low and stable communication cannot be performed, the management device 30 may determine that the power supply of the device itself is OFF.

For example, in a case where the communication connection strengths of all the devices 20 among devices participating in the same local communication network are low, the management device 30 forcibly turns off the functions of the device 10. Detection of utterance of the user U1 is halted, or transmission of an utterance flag is halted. For example, a forcible control signal for forcibly turning off the functions of the device 10 is transmitted from the management device 30 to the device 10. The device 10 that has received the forcible control signal enters a state in which the functions thereof are forcibly turned off, and during this state, the processing of the flowchart of the device 10 in FIG. 2 described above is halted.

In addition, in a case where the communication connection strengths of all the devices 10 among devices participating in the same local communication network are low, the management device 30 forcibly turns off the functions of the device 20. The reception of the utterance flag is stopped, or the control of ON and OFF of the hearing aid processing based on the utterance flag is halted. For example, a forcible control signal for forcibly turning off the functions of the device 20 is transmitted from the management device 30 to the device 20. The device 20 that has received the forcible control signal enters a state in which the functions thereof are forcibly turned off, and during this state, the processing of the flowchart of the device 20 in FIG. 2 described above is halted.

In a case where the above two states, namely, the states where the communication connection strengths of the device 10 and the device 20 are low, are released, the management device 30 releases the forced OFF state of the functions of the devices. For example, a control signal for instructing release is transmitted from the management device 30 to the device 10 or the device 20. The control signal may be a control signal for forcibly turning on the function of the device. The state is released in which the functions of the device 10 or the device 20 that have received the control signal are forcibly turned off, and the processing of the flowchart of the device 10 or the processing of the flowchart of the device 20 in FIG. 2 described above are resumed.

A low communication connection strength of the device 10 or the device 20 means that the distance between the devices is large. In a case of near-field communication such as BT, this means that the device 10 and the device 20 are separated from each other to such an extent that the utterance sound of the user U1 does not reach the user U2. In such a case, conversation between the user U1 and the user U2 does not take place, and thus the functions of the device 10 or the device 20 may be turned off. With the management device 30 automatically and forcibly turning off the functions of the device 10 or the device 20 in the above manner, it is possible to reduce power consumption.

The forcible control signal may be generated in response to a user operation and transmitted to each device.

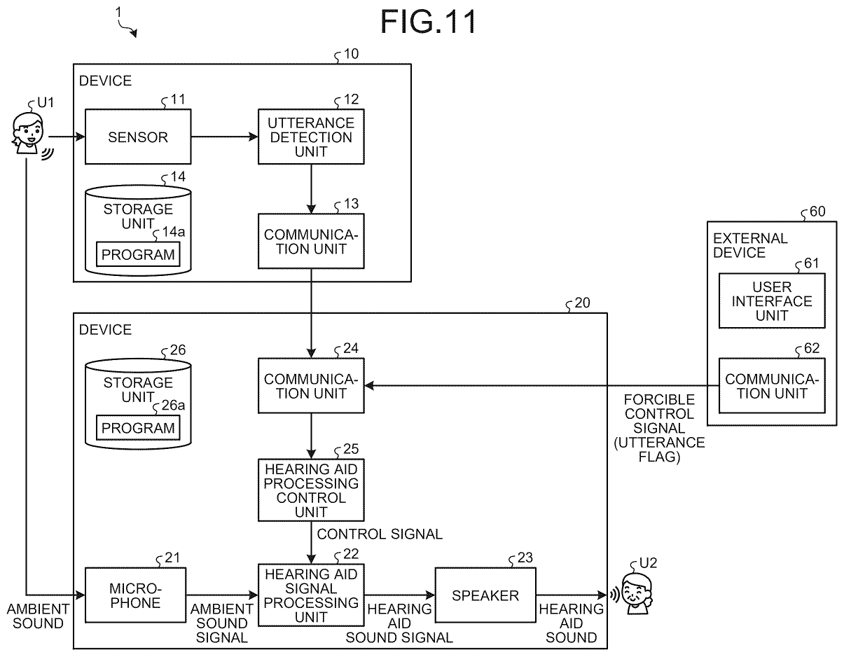

The above-described forcible control signal may include an utterance flag. In that case, an external device such as the management device 30 may turn on the hearing aid processing of the device 20 by transmitting an utterance flag indicating the presence of utterance to the device 20. Alternatively, the external device may turn off the hearing aid processing of the device 20 by transmitting an utterance flag indicating absence of utterance to the device 20. This will be described with reference to FIG. 11.

FIG. 11 is a diagram illustrating an example of a schematic configuration of an information processing system. In this example, an external device included in an information processing system 1 is referred to as an external device 60 in the drawing. The external device 60 may be the management device 30 described above or may be a device different from the management device 30. The external device 60 includes a user interface unit 61 and a communication unit 62. For example, the communication unit 62 transmits a forcible control signal to a device 20 in response to a user operation received via the user interface unit 61. For example, the external device 60 forcibly controls the ON state of the hearing aid processing by the device 20 by transmitting an utterance flag indicating absence of utterance to the device 20.

In a case where a device 10 transmits an utterance flag to the device 20 only when detecting utterance of the user U1, the external device 60 turns on the hearing aid processing of the device 20 by transmitting an utterance flag indicating the presence of the utterance to the device 20. Alternatively, the external device 60 turns off the hearing aid processing of the device 20 by transmitting an utterance flag indicating absence of utterance to the device 20.

In a case where the device 10 transmits an utterance flag to the device 20 at regular intervals, the external device 60 turns on the hearing aid processing of the device 20 by repeatedly keep transmitting an utterance flag indicating the presence of the utterance to the device 20. Alternatively, the external device 60 may turn off the hearing aid processing of the device 20 by repeatedly keep transmitting an utterance flag indicating absence of utterance to the device 20.

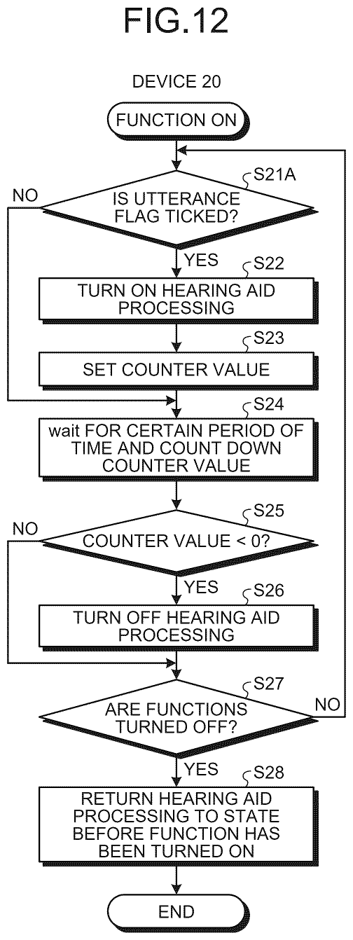

FIG. 12 is a flowchart illustrating an example of processing (information processing method) executed in the information processing system. Illustrated in the example is processing executed in the device 20, and as compared with FIG. 2 described above, processing of Step S21A is executed in place of the processing of Step S21.

In Step S21A, the utterance flag is ticked. For example, if a forcible control signal for forcibly turning on the functions of the device 20 is received, the processing proceeds to Step S22 (Step S21A: Yes). If there is no such forcing, processing in accordance with the utterance flag is executed similarly to Step S21 in FIG. 2 described above. That is, in a case where the utterance flag is received, the processing proceeds to Step S22 (Step S21A: Yes), and otherwise, the processing proceeds to Step S24 (Step S21A: No). Since the remaining flow has been described above with reference to FIG. 2, description thereof will be omitted.

### 3.8. Adjustment of Hearing Aid Sound and Other Sound

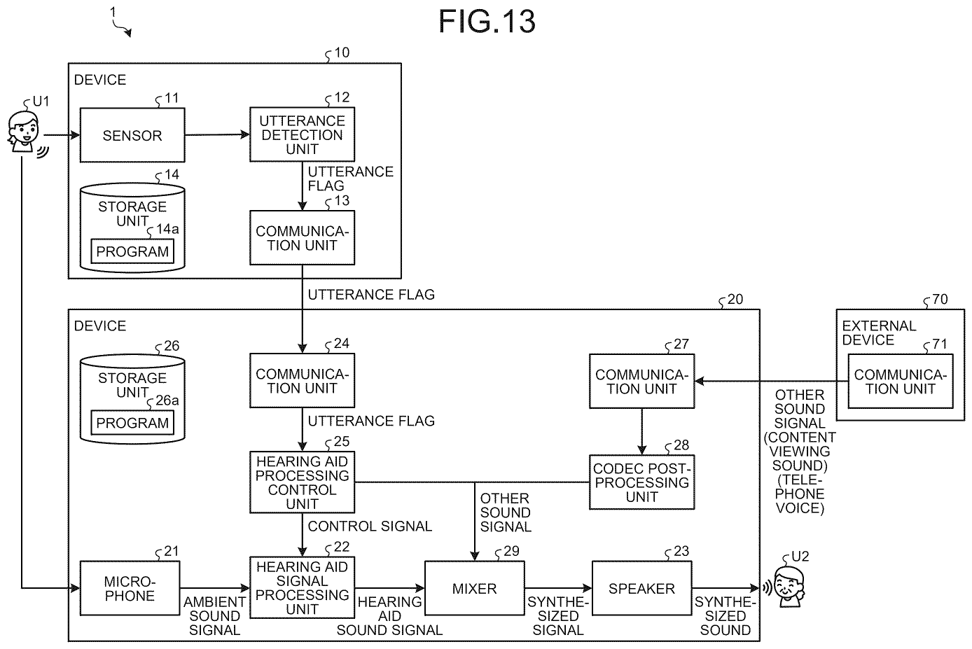

In one embodiment, the device 20 may be used by the user U2 also for listening to sound other than the hearing aid sound (other sound). Examples of the other sound include content viewing sound such as music and a moving image, telephone voice, and others. The device 20 may adjust the volume of at least one of the hearing aid sound or the other sound and then simultaneously output these pieces of sound. This will be described with reference to FIG. 13.

FIG. 13 is a diagram illustrating an example of a schematic configuration of an information processing system. An information processing system 1 includes an external device 70. The external device is a device used by the user U2 to view content or make a call. The external device 70 may be the same device as the management device 30 or the external device 60 described above or may be a different device. The external device 70 includes a communication unit 71. The communication unit 71 communicates with other devices, in this example, a device 20. The communication unit 71 transmits a signal of other sound (other sound signal), such as content viewing sound or telephone voice, to a device 20.

In the example illustrated in FIG. 13, the device 20 includes a communication unit 27, a codec post-processing unit 28, and a mixer 29. The communication unit 27 receives the other sound signal transmitted by the external device 70. The codec post-processing unit 28 performs decoding, post-processing, and others of the other sound signal received by the communication unit 27. In the post-processing, for example, the other sound is adjusted so as to have frequency characteristics suitable for the user U2. The mixer 29 generates a synthesized signal containing both a hearing aid sound signal from a hearing aid signal processing unit 22 and the other sound signal from the codec post-processing unit 28. A speaker 23 outputs sound corresponding to the synthesized signal (synthesized sound) to the user U2. The user U2 can listen to the synthesized sound including the hearing aid sound and the other sound.

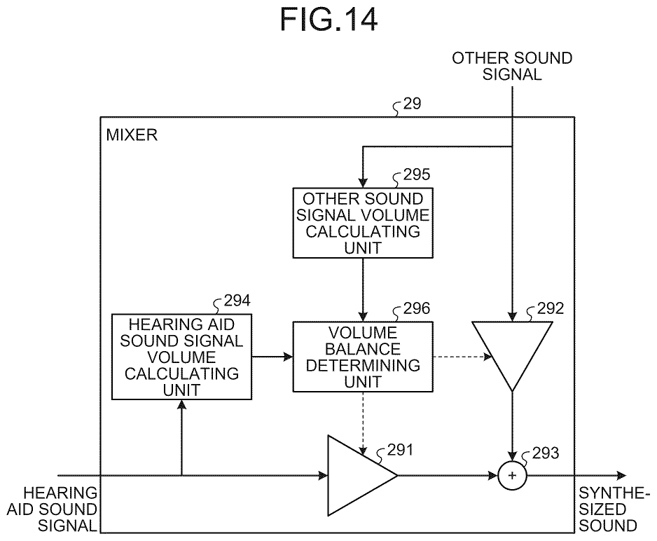

The volume of the hearing aid sound and the volume of the other sound contained in the synthesized sound can be adjusted by adjusting the signal levels of the hearing aid sound signal and the other sound signal combined by the mixer 29. This will be described also with reference to FIG. 14.

FIG. 14 is a diagram illustrating an example of a schematic configuration of the mixer. In this example, the mixer 29 includes a level adjuster 291, a level adjuster 292, an adder 293, a hearing aid sound signal volume calculating unit 294, an other sound signal volume calculating unit 295, and a volume balance determining unit 296.

The level adjuster 291 adjusts the signal level of the hearing aid sound signal. The level adjuster 292 adjusts the signal level of the other sound signal. The adder 293 generates a synthesized sound of the hearing aid sound signal whose signal level has been adjusted by the level adjuster 291 and the other sound whose signal level has been adjusted by the level adjuster 292.

The hearing aid sound signal volume calculating unit 294 calculates the volume of the hearing aid sound signal input to the level adjuster 291. The other sound signal volume calculating unit 295 calculates the volume of the other sound signal input to the level adjuster 292.

For example, an average volume for each processing unit is calculated, and an exponential average thereof is obtained by a primary IIR filter or the like to calculate a moving average having a time constant of about several seconds.

The volume balance determining unit 296 determines a balance (volume balance) between the volume of the hearing aid sound and the volume of the other sound to be contained in the synthesized sound on the basis of the calculation result of the hearing aid sound signal volume calculating unit 294 and the calculation result of the other sound signal volume calculating unit 295. More specifically, the volume balance determining unit 296 controls level adjustment of the hearing aid sound signal by the level adjuster 291 such that the volume of the hearing aid sound is set to the determined volume. In addition, the volume balance determining unit 296 controls level adjustment of the other sound signal by the level adjuster 292 such that the volume of the other sound is set to the determined volume.

Some examples of the determination by the volume balance determining unit 296 will be described. Let the volume of the hearing aid sound signal calculated by the hearing aid sound signal volume calculating unit 294 be L1 (dB). Let the volume of the other sound signal calculated by the other sound signal volume calculating unit 295 be L2 (dB).

For example, in a case where the priority of the other sound is higher out of the hearing aid sound and the other sound, the adjustment level of L1 by the level adjuster 291 is fixed to 0 dB (1.0 times). The adjustment level of L2 by the level adjuster 292 is set to max((L2−L1−Ld), 0) (dB). The level of the other sound signal is adjusted to be higher by max((L2−L1−Ld), 0) (dB). Ld is a target as a level difference between L2 and L1, which may be desirably set.

For example, in a case where the priority of the hearing aid sound is higher out of the hearing aid sound and the other sound, the adjustment level of L1 by the level adjuster 291 is fixed to 0 dB (1.0 times). The adjustment level of L2 by the level adjuster 292 is set to min((L1−L2−Le), 0) (dB). That is, the signal level of the other sound signal is adjusted to be lower by min ((L1−L2−Le), 0) (dB). Le is a target of the level difference between L1 and L2, which may be desirable set.

### 4. Example of Hearing Aid System

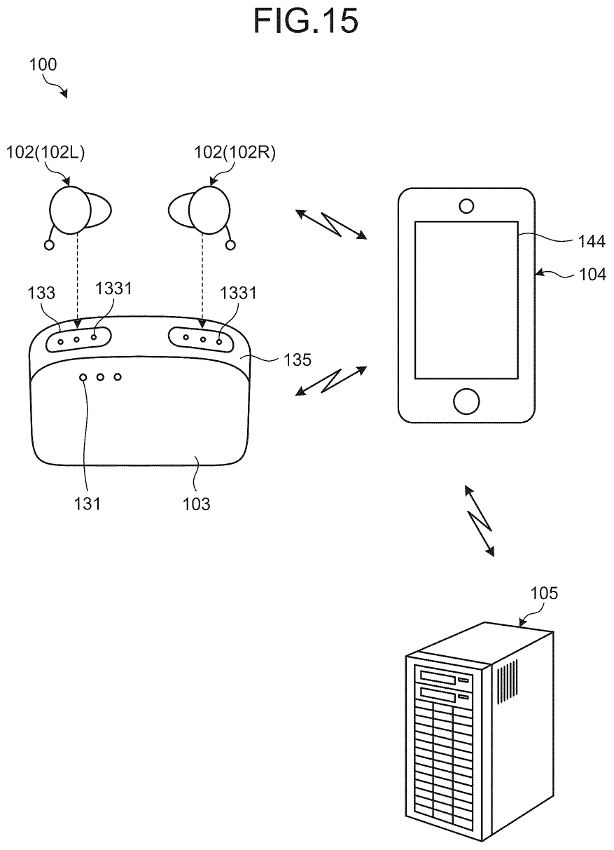

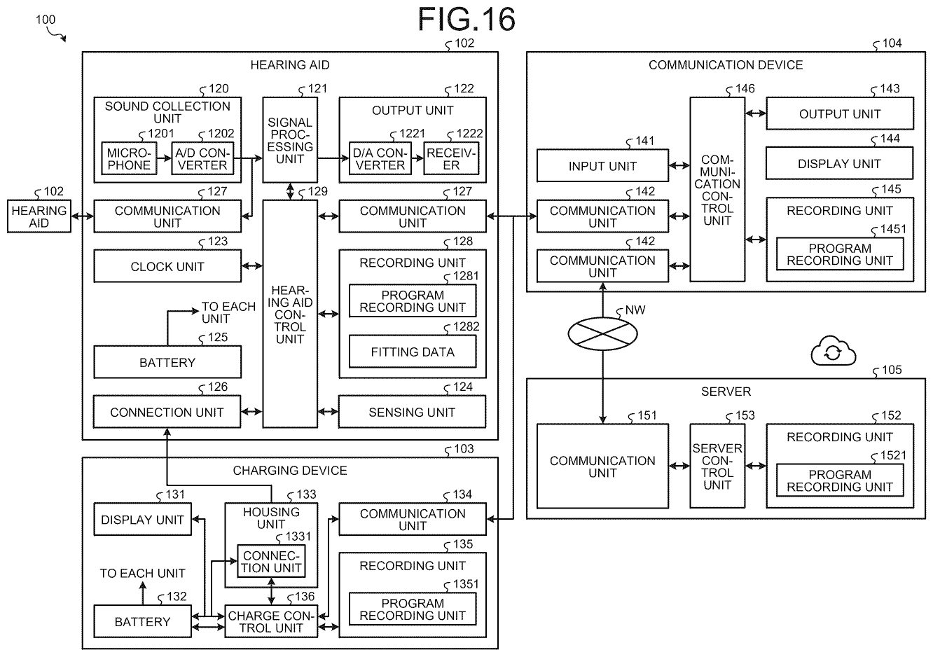

As described above, for example, the device 20 functions as a hearing aid device. A hearing aid system including a hearing aid device will be described with reference to FIGS. 15 and 16. Hereinafter, the hearing aid device is simply referred to as a hearing aid.

### [Outline of Hearing Aid System]

FIG. 15 is a diagram illustrating a schematic configuration of a hearing aid system. FIG. 16 is a block diagram illustrating a functional configuration of the hearing aid system. A hearing aid system 100 illustrated in the example includes a pair of left and right hearing aids 102, a charging device 103 (charging case) that houses the hearing aids 102 and charges the hearing aids 102, a communication device 104 such as a mobile phone capable of communicating with at least one of the hearing aids 102 or the charging device 103, and a server 105. Note that the communication device 104 and the server 105 can be used as, for example, the management device 30, the external device 60, the external device 70, or the like described above. Incidentally, the hearing aids 102 may be, for example, a sound collector or an earphone, a headphone, or the like having a hearing aid function. In addition, the hearing aids 102 may be configured as a single device instead of a pair of left and right devices.

Note that, in this example, a case where the hearing aids 102 are of an air conduction type will be described; however, it is not limited thereto, and for example, a bone conduction type can also be applied.

Furthermore, in this example, a case where the hearing aids 102 are of an ear hole type (in-the-ear (ITE)/in-the-canal (ITC)/completely-in-the-canal (CIC)/invisible-in-the-canal (IIC), and the like) will be described; however, it is not limited thereto, and for example, an ear hook type (behind-the-ear (BTE)/receiver-in-the-canal (RIC), and the like), a headphone type, a pocket type, or the like can also be applied. Furthermore, in this example, a case where the hearing aids 102 are of a binaural type will be described; however, it is not limited thereto, and a single ear type to be worn on one of the left and right ears can also be applied. In the following description, a hearing aid 102 to be worn on the right ear is referred to as a hearing aid 102R, and a hearing aid 102 to be worn on the left ear is referred to as a hearing aid 102L. In a case where one of the left and right hearing aids is referred to, it is simply referred to as a hearing aid 102.

### [Configuration of Hearing Aid]

A hearing aid 102 includes a sound collection unit 120, a signal processing unit 121, an output unit 122, a clock unit 123, a sensing unit 124, a battery 125, a connection unit 126, a communication unit 127, a recording unit 128, and a hearing aid control unit 129. Note that, in the example illustrated in FIG. 16, there are two divided communication units 127. The communication units 127 may be two separate functional blocks or may be one same functional block.

The sound collection unit 120 includes a microphone 1201 and an A/D converter 1202. The microphone 1201 collects external sound, generates an analog sound signal (acoustic signal), and outputs the analog sound signal to the A/D converter 1202. For example, the microphone 1201 functions as the microphone 21 described above with reference to FIG. 1 and, for example, detects ambient sound. The A/D converter 1202 performs A/D conversion processing on the analog sound signal input from the microphone 1201 and outputs a digital sound signal to the signal processing unit 121. Note that the sound collection unit 120 may include both an outer (feed-forward) sound collection unit and an inner (feedback) sound collection unit or may include either one.

Under control of the hearing aid control unit 129, the signal processing unit 121 performs predetermined signal processing on the digital sound signal input from the sound collection unit 120 and outputs the digital sound signal to the output unit 122. For example, the signal processing unit 121 functions as the hearing aid signal processing unit 22 described above with reference to FIG. 1. In this case, predetermined signal processing by the signal processing unit 121 includes the hearing aid processing of generating a hearing aid sound signal from the ambient sound signal. More specific examples of the signal processing include filtering processing of separating a sound signal for each predetermined frequency band, amplification processing of amplifying the sound signal with a predetermined amplification amount for each predetermined frequency band on which the filtering processing has been performed, noise reduction processing, noise canceling processing, beamforming processing, howling cancellation processing, and others. The signal processing unit 121 includes a memory and a processor having hardware such as a digital signal processor (DSP). When a user enjoys stereophonic content using the hearing aid 102, the signal processing unit 121 or the hearing aid control unit 129 may perform various types of stereophonic sound processing such as rendering processing or convolution processing such as a head related transfer function (HRTF). Furthermore, in a case of stereophonic sound content supporting head tracking, head tracking processing may be performed by the signal processing unit 121 or the hearing aid control unit 129.

The output unit 122 includes a D/A converter 1221 and a receiver 1222. The D/A converter 1221 performs a D/A conversion processing on the digital sound signal input from the signal processing unit 121 and outputs the digital sound signal to the receiver 1222. The receiver 1222 outputs output sound (sound) corresponding to the analog sound signal input from the D/A converter 1221. The receiver 1222 includes, for example, a speaker. For example, the receiver 1222 functions as the speaker 23 described above with reference to FIG. 1 and, for example, outputs hearing aid sound.

The clock unit 123 clocks the date and time and outputs the clocking result to the hearing aid control unit 129. The clock unit 123 includes a timing generator, a timer having a clocking function, or the like.

The sensing unit 124 receives an activation signal for activating the hearing aid 102 or input from various sensors to be described later and outputs the received activation signal to the hearing aid control unit 129. The sensing unit 124 includes various sensors.

Examples of the sensors include a wearing sensor, a touch sensor, a position sensor, a motion sensor, and a biological sensor. Examples of the mounting sensor include an electrostatic sensor, an IR sensor, and an optical sensor. Examples of the touch sensor include a push-type switch, a button, and a touch panel (for example, an electrostatic sensor). Examples of the position sensor include a global positioning system (GPS) sensor. Examples of the motion sensor include an acceleration sensor and a gyro sensor. Examples of the biological sensor include a heart rate sensor, a body temperature sensor, and a blood pressure sensor. The processing content in the signal processing unit 121 and the hearing aid control unit 129 may be modified depending on the external sound collected by the sound collection unit 120 or various types of data sensed by the sensing unit 124 (the type of the external sound, position information of the user, or others). Furthermore, a wake word or the like from the user may be collected by the sensing unit 124, and voice recognition processing based on the collected wake word or the like may be performed by the signal processing unit 121 or the hearing aid control unit 129.

The battery 125 supplies power to each unit included in the hearing aid 102. The battery 125 includes a rechargeable secondary battery such as a lithium ion battery. Note that the battery 125 may be other than the lithium ion battery. For example, a zinc-air battery which has been widely used in hearing aids may be used. The battery 125 is charged by power supplied from the charging device 103 via a connection unit 126.

When the hearing aid 102 is housed in the charging device 103 to be described later, the connection unit 126 is connected to a connection unit 1331 of the charging device 103, receives power and various types of information from the charging device 103, and outputs various types of information to the charging device 103. The connection unit 126 includes, for example, one or a plurality of pins.

The communication unit 127 bidirectionally communicates with the charging device 103 or the communication device 104 in accordance with predetermined communication standards under the control by the hearing aid control unit 129. The predetermined communication standards are, for example, communication standards such as a wireless LAN or BT. The communication unit 127 includes a communication module or the like. In a case where communication is performed among a plurality of hearing aids 102, for example, short-range wireless communication standards such as BT, near field magnetic induction (NEMI), or near field communication (NFC) may be used. For example, the communication unit 127 functions as the communication unit 24 described above with reference to FIG. 1. Communication by the communication unit 127 in this case includes reception of an utterance flag and the like.

The recording unit 128 records various types of information regarding the hearing aid 102. The recording unit 128 includes a random access memory (RAM), a read only memory (ROM), a memory card, and the like. The recording unit 128 includes a program recording unit 1281 and fitting data 1282. For example, the recording unit 128 functions as the storage unit 26 described above with reference to FIG. 1 and stores various types of information.

The program recording unit 1281 records, for example, a program executed by the hearing aid 2, various types of data being processed in the hearing aid 2, a log at the time of use, and others. An example of the program is the program 26a described above with reference to FIG. 1.

The fitting data 1282 includes adjustment data of various parameters of the hearing aid device used by the user, for example, a hearing aid gain for each frequency band set on the basis of a hearing measurement result (audiogram) of the user who is a patient or the like, a maximum output sound pressure, and others. Specifically, the fitting data 1282 includes a threshold ratio of a multiband compressor, ON and OFF, intensity setting, or others of various types of signal processing for each use scene. Furthermore, in addition to the user's hearing measurement result (audiogram), adjustment data or the like of various parameters included in the hearing aid device used by the user, which is set on the basis of an exchange between the user and the audiologist, user input on an app as an alternative thereto, calibration involving measurement, or the like, may be included. Note that various parameters of the hearing aid device may be finely adjusted through, for example, counseling with an expert. Furthermore, the fitting data 1282 may also include a user's hearing measurement result (audiogram), which is data that does not generally need to be stored in the hearing aid body, an adjustment formula (for example, NAL-NL, DSL, and the like) used for fitting, and the like. The fitting data 1282 may be stored not only in the recording unit 128 inside the hearing aid 102 but also in the communication device 104 or the server 105. Fitting data may be stored in the recording unit 128 inside the hearing aid 102 and both the communication device 104 and the server 105. For example, by storing the fitting data in the server 105, it is possible to update the fitting data to reflect user's preferences, the degree of change in the user's hearing due to aging, and others, and by downloading the fitting data to the edge device side such as the hearing aid 102, each user can always use fitting data optimized for the user, and thus it is expected that the user experience be further improved.

The hearing aid control unit 129 controls each unit included in the hearing aid 102. The hearing aid control unit 129 includes a memory and a processor having hardware such as a central processing unit (CPU) or a DSP. The hearing aid control unit 129 reads and executes the program recorded in the program recording unit 1281 in a work area of the memory and implements a functional module matching a predetermined purpose by controlling each component or the like through the execution of the program by the processor to cause the hardware and the software to operate in conjunction with each other. For example, the hearing aid control unit 129 functions as the hearing aid processing control unit 25 described above with reference to FIG. 1. The control by the hearing aid control unit 129 in this case includes control such as switching between ON and OFF of the hearing aid processing of the signal processing unit 121 based on the utterance flag received by the communication unit 127.

### [Configuration of Charging Device]

The charging device 103 includes a display unit 131, a battery 132, a housing unit 133, a communication unit 134, a recording unit 135, and a charge control unit 136.

The display unit 131 displays various states related to the hearing aid 102 under control by the charge control unit 136. For example, the display unit 131 displays information indicating that the hearing aid 102 is being charged or that charging has been completed or information indicating that various types of information are received from the communication device 104 or the Server 105. The display unit 131 includes a light emitting diode (LED), a graphical user interface (GUI), or the like.

The battery 132 supplies power to the hearing aid 102 housed in the housing unit 133 and each unit included in the charging device 103 via the connection unit 1331 included in the housing unit 133 described later. Note that power may be supplied to the hearing aid 102 housed in the housing unit 133 and each unit included in the charging device 103 by the battery 132 included in the charging device 103, or power may be wirelessly supplied from an external power supply, for example, as in the Qi standards (registered trademark). The battery 132 includes a secondary battery such as a lithium ion battery. Note that, in this embodiment, in addition to the battery 132, a power supply circuit may be further provided that supplies power to the hearing aid 102 by DC/DC conversion that converts AC power supplied from the outside into DC power and then converts the DC power into a predetermined voltage.

The housing unit 133 individually stores the left and right hearing aids 102. Meanwhile, the housing unit 133 includes a connection unit 1331 connectable to the connection unit 126 of the hearing aid 102.

When the hearing aid 102 is housed in the housing unit 133, the connection unit 1331 is connected to the connection unit 126 of the hearing aid 102, transmits power from the battery 132 and various types of information from the charge control unit 136, receives various types of information from the hearing aid 102, and outputs the information to the charge control unit 136. The connection unit 1331 includes, for example, one or a plurality of pins.

The communication unit 134 communicates with the communication device 104 in accordance with predetermined communication standards under the control by the charge control unit 136. The communication unit 134 includes a communication module. Note that power may be wirelessly supplied from the above-described external power supply to the hearing aid 102 and the charging device 103 via the communication unit 127 of the hearing aid 102 and the communication unit 134 of the charging device 103.

The recording unit 135 includes a program recording unit 1351 that records various programs to be executed by the charging device 103. The recording unit 135 includes a RAM, a ROM, a flash memory, a memory card, and the like. For example, after a firmware update program is acquired from the server 105 via the communication unit 134 and stored in the recording unit 135, the firmware update may be performed while the hearing aid 102 is stored in the housing unit 133. Note that the firmware update may be directly performed from the server 105 via the communication unit 127 of the hearing aid 102 and not via the communication unit 134 of the charging device 103. The firmware update program may be stored not in the recording unit 135 of the charging device 103 but in the recording unit 128 of the hearing aid 102.

The charge control unit 136 controls each unit included in the charging device 103. For example, when the hearing aid 102 is housed in the housing unit 133, the charge control unit 136 supplies power from the battery 132 via the connection unit 1331. The charge control unit 136 includes a memory and a processor having hardware such as a CPU or a DSP. The charge control unit 136 reads and executes the program recorded in the program recording unit 1351 in a work area of the memory and implements a functional module matching a predetermined purpose by controlling each component or the like through the execution of the program by the processor to cause the hardware and the software to operate in conjunction with each other.

### [Configuration of Communication Device]

The communication device 104 includes an input unit 141, a communication unit 142, an output unit 143, a display unit 144, a recording unit 145, and a communication control unit 146. Note that, in the example illustrated in FIG. 16, there are two divided communication units 142. The communication units 142 may be two separate functional blocks or may be one same functional block.

The input unit 141 receives input of various operations from the user and outputs a signal corresponding to the received operation to the communication control unit 146. The input unit 141 includes a switch, a touch panel, or others.

The communication unit 142 communicates with the charging device 103 or the hearing aid 102 under the control by the communication control unit 146. The communication unit 142 includes a communication module.

The output unit 143 outputs in a volume of a predetermined sound pressure level for each predetermined frequency band under the control by the communication control unit 146. The output unit 143 includes a speaker or the like.

The display unit 144 displays various types of information regarding the communication device 104 and information regarding the hearing aid 102 under the control by the communication control unit 146. The display unit 144 includes a liquid crystal display, an organic electroluminescent display (EL display), or the like.

The recording unit 145 records various types of information regarding the communication device 104. The recording unit 145 includes a program recording unit 1451 that records various programs to be executed by the communication device 104. The recording unit 145 includes a recording medium such as a RAM, a ROM, a flash memory, and a memory card.

The communication control unit 146 controls each unit included in the communication device 104. The communication control unit 146 includes a memory and a processor having hardware such as a CPU. The communication control unit 146 reads and executes the program recorded in the program recording unit 1451 in a work area of a memory and implements a functional module matching a predetermined purpose by controlling each component or the like through the execution of the program by the processor to cause the hardware and the software to operate in conjunction with each other.

### [Configuration of Server]

The server 105 includes a communication unit 151, a recording unit 152, and a server control unit 153.

The communication unit 151 communicates with the communication device 104 via a network NW under control by the server control unit 153. The communication unit 151 includes a communication module. An example of the network NW is a Wi-Fi (registered trademark) network or the like.

The recording unit 152 records various types of information regarding the server 105. The recording unit 152 includes a program recording unit 1521 that records various programs to be executed by the server 105. The recording unit 152 includes a recording medium such as a RAM, a ROM, a flash memory, and a memory card.

The server control unit 153 controls each unit included in the server 105. The server control unit 153 includes a memory and a processor having hardware such as a CPU. The server control unit 153 reads and executes the program recorded in the program recording unit 1521 in a work area of a memory and implements a functional module matching a predetermined purpose by controlling each component or the like through the execution of the program by the processor to cause the hardware and the software to operate in conjunction with each other.

### 5. Examples of Data Utilization

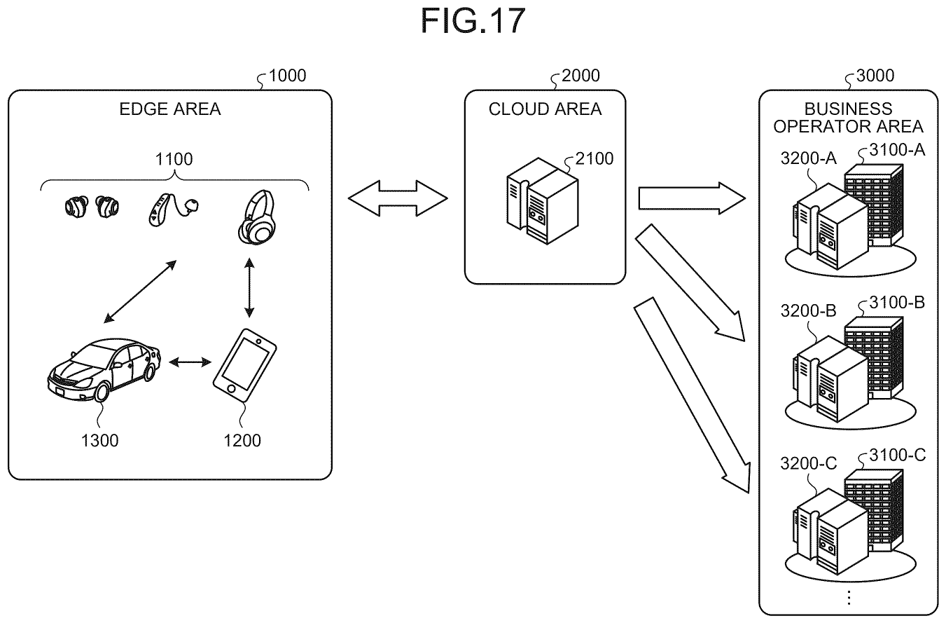

Data obtained in relation to the utilization of the hearing aid device may be utilized in various manners. An example will be described with reference to FIG. 17.

FIG. 17 is a diagram illustrating examples of utilization of data. In the illustrated system, there are an edge area 1000, a cloud area 2000, and a business operator area 3000. Examples of elements in the edge area 1000 include sound producing devices 1100, a peripheral device 1200, and a vehicle 1300. A server device 2100 is illustrated as an example as an element in the cloud area 2000. Business operators 3100 and server devices 3200 are illustrated as examples as elements in the business operator area 3000.

The sound producing devices 1100 in the edge area 1000 are used by being worn by a user or disposed near the user so as to emit sound toward the user. Specific examples of the sound producing device 1100 include earphones, a headset, and a hearing aid. For example, the device 10 and the device 20 described above with reference to FIG. 1 and others and the hearing aids 102 described with reference to FIG. 15 and the like may be used as a sound producing device 1100.

The peripheral device 1200 and the vehicle 1300 in the edge area 1000 are devices used together with the sound producing device 1100 and transmit signals of content viewing sound, telephone voice, or the like to the sound producing device 1100. The sound producing device 1100 outputs sound corresponding to the signals from the peripheral device 1200 or the vehicle 1300 to the user. A specific example of the peripheral device 1200 is a smartphone or the like. For example, the external device 70 described above with reference to FIG. 13 and others may be used as the peripheral device 1200.

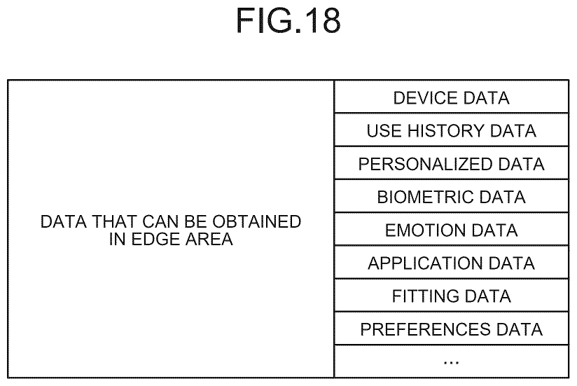

In the edge area 1000, various types of data regarding utilization of the sound producing device 1100 may be obtained. This will be described also with reference to FIG. 18.

FIG. 18 is a table illustrating an example of data. Examples of data that can be acquired in the edge area 1000 include device data, use history data, personalized data, biometric data, emotion data, application data, fitting data, and preferences data. Note that the term data may be understood as meaning information, and these may be interchangeably read as appropriate as long as there is no contradiction. Various known methods may be used to acquire the data illustrated as the examples.

The device data is related to the sound producing device 1100 and includes, for example, type data of the sound producing device 1100, specifically, data identifying that the sound producing device 1100 is an earphone, a headphone, a TWS, a hearing aid (CIC, ITE, RIC, etc.), or the like.

The use history data is use history data of the sound producing device 1100 and includes, for example, data such as a music exposure dose, a continuous use time of the hearing aid, or a content viewing history (such as viewing time). Furthermore, the use history data may also include the use time, the number of times of use, and the like of the functions such as transmission of an utterance flag in the embodiments described above. The use history data can be used for safe listening, making a TWS a hearing aid, replacement notification of wax guard, and others.

The personalized data is related to the user of the sound producing device 1100 and includes, for example, an HRTF of an individual, ear canal characteristics, the type of earwax, and others. Data such as hearing may also be included in the personalized data.

The biometric data is biometric data of the user of the sound producing device 1100 and includes, for example, data such as perspiration, the blood pressure, the body temperature, the blood flow, and brain waves.

The emotion data indicates the emotion of the user of the sound producing device 1100 and includes, for example, data indicating comfort, discomfort, or others.

The application data is data, for example, used in various applications and includes, for example, data such as the position of the user of the sound producing device 1100 (may be the position of the sound producing device 1100), schedule, age, gender, or others as well as data such as weather. For example, the position data can be used to look for a missing sound producing device 1100 (such as HA).

The fitting data may be the fitting data 1282 described above with reference to FIG. 16 and includes, for example, data such as hearing (which may be derived from an audiogram), adjustment of sound image localization, and beamforming. Data such as behavioral characteristics may also be included in the fitting data.

The preferences data is related to preferences of the user and includes, for example, data such as preferences of music to listen to during driving.

The above data is an example, and data other than the above may be acquired. For example, data of a communication band, a communication status, data of a charging status of the sound producing device 1100, and the like may also be acquired. A part of processing in the edge area 1000 may be executed by the cloud area 2000 depending on the band, the communication status, the charging status, or others. With the processing shared, the processing load in the edge area 1000 is reduced.

Returning to FIG. 17, for example, data as described above is acquired in the edge area 1000 and transmitted from the sound producing device 1100, the peripheral device 1200, or the vehicle 1300 to the server device 2100 in the cloud area 2000. The server device 2100 records (store, accumulate, etc.) the received data.

The business operator 3100 in the business operator area 3000 uses the server device 3200 to acquire data from the server device 2100 in the cloud area 2000. This allows the business operator 3100 to utilize the data.

There may be various business operators 3100. Specific examples of the business operator 3100 are a hearing aid store, a hearing aid manufacturer, a content production company, a distribution business operator providing music streaming services, and the like, which are referred to as a business operator 3100-A, a business operator 3100-B, and a business operator 3100-C so as to distinguish them. Corresponding server devices 3200 are referred to as a server device 3200-A, a server device 3200-B, and a server device 3200-C in the drawing. Various types of data are provided to such various business operators 3100, whereby data utilization is promoted. The data provision to the business operators 3100 may be, for example, data provision by subscription, recurring, or the like.

Data can be provided also from the cloud area 2000 to the edge area 1000. For example, in a case where machine learning is required to implement processing in the edge area 1000, data for feedback, revision (revise), and the like of training data is prepared by an administrator or the like of the server device 2100 in the cloud area 2000. The prepared data is transmitted from the server device 2100 to the sound producing device 1100, the peripheral device 1200, or the vehicle 1300 in the edge area 1000.

In a case where a specific condition is satisfied in the edge area 1000, some type of incentive (benefit such as premium service) may be provided to the user. An example of the condition is that at least some of the sound producing device 1100, the peripheral device 1200, and the vehicle 1300 are provided by the same business operator. In the incentive can be electronically supplied (electronic coupon or the like), the incentive may be transmitted from the server device 2100 to the sound producing device 1100, the peripheral device 1200, or the vehicle 1300.

### 6. Example of Cooperation with Other Devices

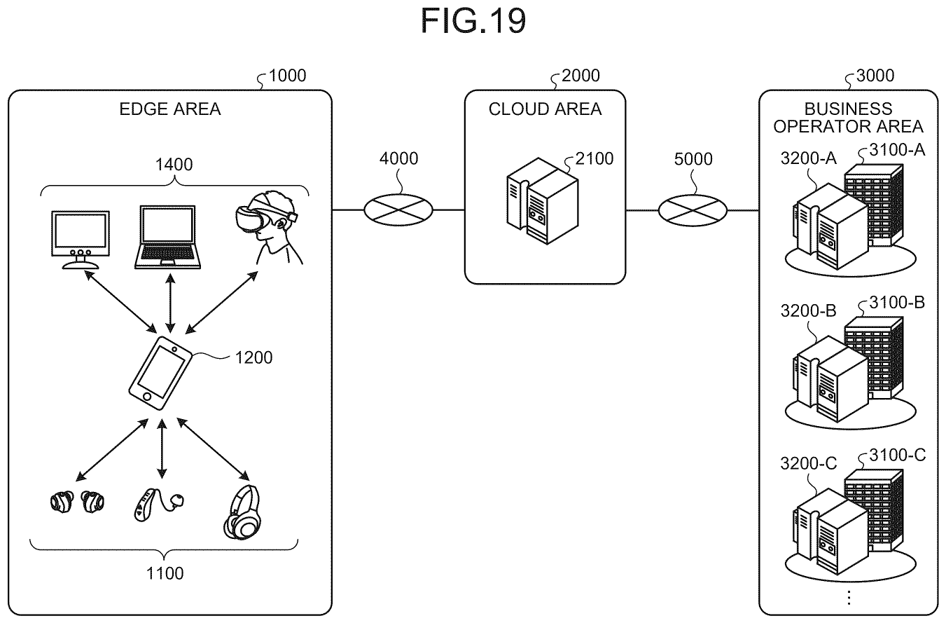

In the edge area 1000, for example, the sound producing device 1100 may cooperate with another device using the peripheral device 1200 such as a smartphone as a hub. An example will be described with reference to FIG. 19.

FIG. 19 is a diagram illustrating an example of cooperation with other devices. The edge area 1000, the cloud area 2000, and the business operator area 3000 are connected by a network 4000 and a network 5000. A smartphone exemplifies the peripheral device 1200 in the edge area 1000, and other devices 1400 further exemplifies elements in the edge area 1000. Note that illustration of the vehicle 1300 (FIG. 17) is omitted.

The peripheral device 1200 can communicate with each of the sound producing devices 1100 and the other devices 1400. The communication method is not particularly limited. For example, Bluetooth LDAC, Bluetooth LE Audio described above, or the like may be used. Communication between the peripheral device 1200 and the other devices 1400 may be multicast communication. An example of the multicast communication is Auracast (registered trademark).

The other devices 1400 are used in cooperation with the sound producing devices 1100 via the peripheral device 1200. Specific examples of the other devices 1400 include a television, a personal computer, and a head mounted display (HMD).

Even in a case where the sound producing devices 1100, the peripheral device 1200, and the other devices 1400 satisfy a specific condition (such as that at least some of the devices are provided by the same business operator), an incentive may be provided to the user.

The sound producing devices 1100 and the other devices 1400 can cooperate with each other using the peripheral device 1200 as a hub. The cooperation may be performed using various types of data stored in the server device 2100 in the cloud area 2000. For example, information such as fitting data, viewing time, or hearing of the user is shared among the sound producing devices 1100 and the other devices 1400, whereby volume adjustment and the like of each device are performed in a coordinated manner. When a hearing aid (HA) or a sound collector (personal sound amplification product (PSAP)) is worn, setting for the HA or the PSAP can be automatically performed on the television, the PC, or others. For example, when a user using the HA uses another device such as the television or the PC, processing of automatically changing the setting of another device may be performed such that the setting is set to be suitable for HA users otherwise normally set to setting suitable for a normal hearing person. Note that whether or not the user is using an HA may be determined by automatically sending information indicating that the user has put on the HA (for example, wearing detection information) to a device such as a television, a PC, or the like that is a pairing destination of the HA when the user wears the HA or may be detected by using approach of the user using the HA to another device such as the target television, the PC, or the like as a trigger. Furthermore, it may be determined that the user is an HA user by capturing an image of the face of the user with a camera or the like included in another device such as a television, a PC, or the like or may be determined by a method other than the above method. The earphones can be also caused to function as hearing aids. The hearing aids can also be used in a style as if listening to music (in terms of motion, appearance, etc.) The earphones, headphones, and hearing aids have many technically overlapping parts, and it is conceivable that the barriers among the earphones, headphones, and hearing aids disappear in the future and that one device has functions as both earphones and a hearing aid. In a case of normal hearing, namely, a normal hearing person, can enjoy a content viewing experience by using the earphones as normal earphones or headphone, and when hearing is lowered due to aging or the like, the function as a hearing aid can be exerted by turning on the hearing aid function. Since the device as earphones can be used also as a hearing aid as it is, continuous and long-term use by the user can be expected also from the viewpoint of appearance and design.

Data of the user's viewing history may be shared. Listening for a long time can be a risk for future hearing difficulties. Notification or the like to the user may be performed so that the listening time does not become too long. For example, when the listening time exceeds a predetermined threshold value, such a notification is made (safe listening). The notification may be performed by any device in the edge area 1000.

At least some of the devices used in the edge area 1000 may be provided by a different business operator. Information regarding device settings and the like of each business may be transmitted from the server device 3200 in the business operator area 3000 to the server device 2100 in the cloud area 2000 and stored in the server device 2100. By using such information, it is also possible to enable devices provided by different business operators to cooperate with each other.

### 7. Example of Application Transition

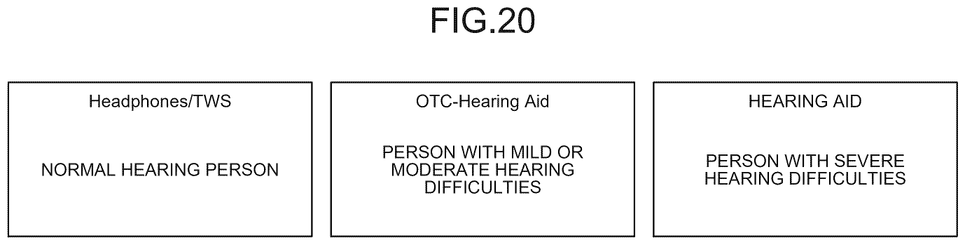

The application of a sound producing device 1100 can transition depending on various situations including fitting data, viewing time, hearing, and others of the user as described above. An example will be described with reference to FIG. 20.

FIG. 20 is a diagram illustrating an example of application transition. In a case where the user is a normal hearing person, for example, while the user is a child and for a while after becoming an adult, the sound producing device 1100 is used as a headphone or earphones (headphones/TWS). In addition to the safe listening described above, adjustment of an equalizer, processing depending on the user's behavior characteristic, current location, and external environment (for example, the noise canceling mode is switched to an optimal noise canceling mode depending on whether the scene is a scene in which the user is at a restaurant or a scene in which the user is onboard a vehicle), collection of a listening music log, and others are performed. Communication between devices using Auracast is also used.

As the user's hearing declines, a hearing aid function of the sound producing device 1100 starts to be used. For example, in a case where the user is a person with mild or moderate hearing difficulties, the sound producing device 1100 is used as an over-the-counter hearing aid (OTC hearing aid). In a case where the user is a person with severe hearing difficulties, the sound producing device 1100 is used as a hearing aid. Note that the OTC hearing aid is a hearing aid that is sold at a store without attendance of an expert and has the ease of purchase without going through a hearing test or an expert such as an audiologist. Operations unique to the hearing aid such as fitting may be performed by the user himself/herself. While the sound producing device 1100 is used as an OCT hearing aid or a hearing aid, hearing measurement is performed or a hearing aid function is turned on. For example, function such as transmission of an utterance flag in the above-described embodiments can also be used. In addition, various types of information regarding hearing (hearing big data) are collected, subjected to fitting, sound environment adaptation, remote support, or others, or further subjected to transcription.

### 8. Exemplary Effects

The technology described above is specified as follows, for example. One piece of the disclosed technology is the information processing system 1. As described with reference to FIGS. 1 and 2 and others, the information processing system 1 includes a plurality of devices that participate in a local communication network. The plurality of devices includes the device 10 (first device) that is used by the user U1 (first user) and functions as the detection device that detects utterance of the user U1 (which may also be a device capable of detecting utterance other than the device 10) and the device 20 (second device) that is used by the user U2 (second user) and functions as the hearing aid device that executes hearing aid processing. The device 10 transmits an utterance flag indicating the presence or absence of utterance to the device 20. In a case where the utterance flag indicates the presence of utterance, the device 20 turns on the hearing aid processing.

According to the information processing system 1 described above, only when the user U1 of the device 10 makes utterance, the utterance flag indicating the presence of utterance is transmitted from the device 10 to the device 20, and the hearing aid processing of the device 20 is turned on. This makes it possible to reduce the listening fatigue of the user U2 due to, for example, the hearing aid processing being constantly ON. The utterance of the user U1 can be, for example, address by the user U2 for starting a conversation with the user U2. Since the hearing aid processing of the device 20 is automatically turned on in response to such utterance of the user U1, the user U2 can smoothly start a conversation with the user U1 while using the device 20 as the hearing aid device. Therefore, it is possible to achieve both reduction of listening fatigue and smooth conversation start.

As described with reference to FIGS. 1 and 3 and the like, the device 10 may be worn on the ear of the user U1. This makes it easier to detect utterance of the user U1.

The utterance flag may include bit data indicating the presence or absence of utterance. For example, the data size of the utterance flag can be made smaller than that in a case where audio streaming data is included.

As described with reference to FIGS. 1 and 2 and others, the device 10 may transmit an utterance flag to the device 20 when detecting utterance of the user U1. Alternatively, the device 10 may transmit the utterance flag to device 20 at regular intervals. For example, the utterance flag can be transmitted at such timing.

As described with reference to FIGS. 4 and 5 and others, at least one of the device 10 or the device 20 may function as both a detection device and a hearing aid device. As a result, the device 10 or the device 20 can be used not only for the use on the speaking side or the use on the listening side but also for the use on both sides.

As described with reference to FIGS. 3 and 5 and others, the plurality of devices may include a plurality of devices 10, each used by a different first user. The plurality of devices may include a plurality of devices 20, each used by a different second user. It is possible to achieve a smooth conversation start among many users.

As described with reference to FIG. 5 and others, the information processing system 1 may include the management device 30 that manages the local communication network, the management by the management device 30 may include at least one of addition, deletion, or setting of a device to participate in the local communication network, and the setting may include a setting of being used as a detection device (both sides or talking side) and setting of being used as a hearing aid device (both sides or listening side). As a result, complicated setting of one or more local communication networks in which many devices may participate can be easily performed.

As described with reference to FIGS. 6 and 7 and others, the information processing system 1 may include the relay device 40 that relays communication between the device 10 and the device 20. For example, an utterance flag can be transmitted from the device 10 to the device 20 in this manner.

As described with reference to FIG. 8 and others, turning on the hearing aid processing may include gradually increasing the signal level of the hearing aid sound signal generated by the hearing aid processing. This makes it possible to smoothly change the volume of the output hearing aid sound.

The utterance flag indicates the probability of the presence or absence of utterance, and turning on the hearing aid processing may include setting the signal level of the hearing aid sound signal generated by the hearing aid processing to a magnitude corresponding to the probability of presence or absence of utterance. This makes it possible to control the volume of the hearing aid sound depending on the probability of the presence of absence of utterance.

As described with reference to FIGS. 9 and 10 and others, the hearing aid processing may include generating a hearing aid sound signal on the basis of the speaker feature amount of the user U1. As a result, for example, in a low S/N environment, it is possible to generate such a hearing aid sound signal that emphasizes the voice of the user U1.

As described with reference to FIGS. 11, 12, and the like, the information processing system 1 includes the external device 60 that controls a plurality of devices, and the control by the external device 60 may include at least one of forcibly halting an ON state of the hearing aid processing by the device 10 when the communication connection strength of the device 20 is low (turning off the function of the device 20) or forcibly stopping transmission of the utterance flag by the device 20 when the communication connection strength of the device 10 is low (turning off the function of the device 10). For example, the external device 60 may forcibly halt the ON state of the hearing aid processing by the device 20 by transmitting an utterance flag indicating absence of utterance to the device 20. Accordingly, it is possible to reduce the power consumption of the device 10 or the device 20.

As described with reference to FIG. 13 and others, the device 20 may adjust the volume of at least one of the hearing aid sound or the other sound and simultaneously output the hearing aid sound and the other sound, the volume of at least one of the hearing aid sound or the other sound adjusted, and the other sound may include at least one of content viewing sound or telephone voice. As a result, the user U2 can listen to the synthesized sound including the hearing aid sound and the other sound each volume of which is appropriately adjusted.

The device 20 described with reference to FIGS. 1 and 2 and others is also one piece of the disclosed technology. The device 20 participates in the local communication network together with the device 10 (the other device), executes the hearing aid processing, and turns on the hearing aid processing in a case where an utterance flag indicating presence or absence of utterance transmitted by the device 10 indicates presence of utterance. Also with such a device 20, it is possible to achieve both reduction of listening fatigue and smooth conversation start as described above.

The device 10 described with reference to FIGS. 1 and 2 and others is also one piece of the disclosed technology. The device 10 participates in the local communication network together with the device 20 (the other device) and detects utterance of the user U1 and transmits an utterance flag indicating presence or absence of utterance to the device 20. Also with such a device 10, it is possible to achieve both reduction of listening fatigue and smooth conversation start as described above.

The information processing method described with reference to FIG. 2 and others is also one piece of the disclosed technique. The information processing method is performed by a plurality of devices participating in the local communication network. The plurality of devices includes the device 10 (first device) that is used by the user U1 (first user) and functions as the detection device that detects utterance of the user U1 and the device 20 (second device) that is used by the user U2 (second user) and functions as the hearing aid device that executes hearing aid processing. The information processing method includes: transmitting, by the device 10, an utterance flag indicating presence or absence of utterance to the device 20 (Step S12); and turning on the hearing aid processing by the device 20 in a case where the utterance flag indicates presence of utterance (Step S22). Also with such an information processing method, it is possible to achieve both reduction of listening fatigue and smooth conversation start as described above.

The programs (program 14a and program 26a) described with reference to FIG. 1 and others is also one piece of the disclosed technology. The program causes a computer to function as a plurality of devices that participate in the local communication network. The plurality of devices includes the device 10 (first device) that is used by the user U1 (first user) and functions as the detection device that detects utterance of the user U1 and the device 20 (second device) that is used by the user U2 (second user) and functions as the hearing aid device that executes hearing aid processing. The device 10 transmits an utterance flag indicating the presence or absence of utterance to the device 20, In a case where the utterance flag indicates the presence of utterance, the device 20 turns on the hearing aid processing. Also with such a program, it is possible to achieve both reduction of listening fatigue and smooth conversation start as described above. Note that a computer-readable recording medium in which the program is recorded is also one piece of the disclosed technology.

Note that the effects described herein are merely examples, and it is not limited to the disclosed content. There may be other effects.

Although the embodiments of the disclosure have been described above, the technical scope of the disclosure is not limited to the above embodiments as they are, and various modifications can be made without departing from the gist of the disclosure. In addition, components of different embodiments and modifications may be combined as appropriate.

Note that the present technology can also have the following configurations.
(1) An information processing system comprising:
   a plurality of devices participating in a local communication network,
   wherein the plurality of devices comprises:
      a first device used by a first user, the first device functioning as a detection device that detects utterance of the first user; and
      a second device used by a second user, the second device functioning as a hearing aid device that executes hearing aid processing,
   the first device transmits an utterance flag indicating presence or absence of utterance to the second device, and
   the second device turns on the hearing aid processing in a case where the utterance flag indicates presence of utterance.
(2) The information processing system according to (1),
   wherein the first device is worn on an ear of the first user.
(3) The information processing system according to (1) or (2),
   wherein the utterance flag includes bit data indicating presence or absence of utterance.
(4) The information processing system according to any one of (1) to (3),
   wherein the first device transmits the utterance flag to the second device in a case where utterance of the first user is detected.
(5) The information processing system according to any one of (1) to (3),
   wherein the first device transmits the utterance flag to the second device at regular intervals.
(6) The information processing system according to any one of (1) to (5),
   wherein at least one of the first device or the second device functions as both the detection device and the hearing aid device.
(7) The information processing system according to any one of (1) to (6),
   wherein the plurality of devices includes a plurality of the first devices each used by the first user, a plurality of the first users being different from each other.
(8) The information processing system according to any one of (1) to (7),
   wherein the plurality of devices includes a plurality of the second devices each used by the second user, a plurality of the second users being different from each other.
(9) The information processing system according to any one of (1) to (8), further comprising:
   a management device that manages the local communication network,
   wherein the management by the management device includes at least one of addition, deletion, or setting of a device to participate in the local communication network, and
   the setting includes setting to be used as the detection device and setting to be used as the hearing aid device.
(10) The information processing system according to any one of (1) to (9), further comprising:
   a relay device that relays communication between the first device and the second device.
(11) The information processing system according to any one of (1) to (10),
   wherein turning on the hearing aid processing includes gradually increasing a signal level of a hearing aid sound signal generated by the hearing aid processing.
(12) The information processing system according to any one of (1) to (11),
   wherein the utterance flag indicates a probability of presence or absence of utterance, and
   turning on the hearing aid processing includes setting a signal level of a hearing aid sound signal generated by the hearing aid processing to a level corresponding to the probability of presence or absence of utterance.
(13) The information processing system according to any one of (1) to (12),
   wherein the hearing aid processing includes generating a hearing aid sound signal on a basis of a speaker feature amount of the first user.
(14) The information processing system according to any one of (1) to (13), further comprising:
   an external device that controls the plurality of devices,
   wherein control by the external device comprises:
   at least one of forcibly halting ON of the hearing aid processing by the second device in a case where communication connection strength of the first device is low or forcibly halting transmission of the utterance flag by the first device in a case where the communication connection strength of the second device is low.
(15) The information processing system according to (14),
   wherein the external device forcibly halts an ON state of the hearing aid processing by the second device by transmitting an utterance flag indicating absence of utterance to the second device.
(16) The information processing system according to any one of (1) to (15),
   wherein the second device adjusts a volume of at least one of hearing aid sound or other sound and simultaneously outputs the hearing aid sound and the other sound, the volume of at least one of the hearing aid sound or the other sound adjusted, and
   the other sound includes at least one of content viewing sound or telephone voice.
(17) A device that participates in a local communication network together with another device and executes hearing aid processing,
   wherein the device turns on the hearing aid processing in a case where an utterance flag indicating presence or absence of utterance transmitted by the other device indicates presence of utterance.
(18) A device that participates in a local communication network together with another device and detects utterance of a user,
   wherein the device transmits an utterance flag indicating presence or absence of utterance to the other device.
(19) An information processing method performed by a plurality of devices participating in a local communication network,
   the plurality of devices comprising:
      a first device used by a first user, the first device functioning as a detection device that detects utterance of the first user; and
      a second device used by a second user, the second device functioning as a hearing aid device that executes hearing aid processing,
   the information processing method comprising the steps of:
   by the first device, transmitting an utterance flag indicating presence or absence of utterance to the second device, and
   by the second device, turning on the hearing aid processing in a case where the utterance flag indicates presence of utterance.
(20) A program for causing a computer to function as a plurality of devices participating in a local communication network,
   wherein the plurality of devices includes:
      a first device used by a first user, the first device functioning as a detection device that detects utterance of the first user; and
      a second device used by a second user, the second device functioning as a hearing aid device that executes hearing aid processing for assisting hearing aid of the second user,
   the first device transmits an utterance flag indicating presence or absence of utterance to the second device, and
   the second device turns on the hearing aid processing in a case where the utterance flag indicates presence of utterance.

### REFERENCE SIGNS LIST

1 INFORMATION PROCESSING SYSTEM
10 DEVICE (FIRST DEVICE)
11 SENSOR
12 UTTERANCE DETECTION UNIT
13 COMMUNICATION UNIT
14 STORAGE UNIT
14a PROGRAM
20 DEVICE (SECOND DEVICE)
21 MICROPHONE
22 HEARING AID SIGNAL PROCESSING UNIT
221 HEARING AID SIGNAL GENERATING UNIT
222 LEVEL ADJUSTER
23 SPEAKER
24 COMMUNICATION UNIT
25 HEARING AID PROCESSING CONTROL UNIT
26 STORAGE UNIT
26a PROGRAM
27 COMMUNICATION UNIT
28 CODEC POST-PROCESSING UNIT
29 MIXER
291 LEVEL ADJUSTER
292 LEVEL ADJUSTER
293 ADDER
294 HEARING AID SOUND SIGNAL VOLUME CALCULATING UNIT
295 OTHER SOUND SIGNAL VOLUME CALCULATING UNIT
30 MANAGEMENT DEVICE
31 USER INTERFACE UNIT
40 RELAY DEVICE
41 COMMUNICATION UNIT
51 SPEAKER FEATURE AMOUNT CALCULATING UNIT
52 TIME-FREQUENCY MASK ESTIMATING UNIT
60 EXTERNAL DEVICE
61 USER INTERFACE UNIT
62 COMMUNICATION UNIT
U1 USER (FIRST USER)
U2 USER (SECOND USER)
U3 USER (FIRST USER)
R ROOM
R1 ROOM
R2 ROOM

1. An information processing system comprising:
a plurality of devices participating in a local communication network,
wherein the plurality of devices comprises:
a first device used by a first user, the first device functioning as a detection device that detects utterance of the first user; and
a second device used by a second user, the second device functioning as a hearing aid device that executes hearing aid processing,
the first device transmits an utterance flag indicating presence or absence of utterance to the second device, and
the second device turns on the hearing aid processing in a case where the utterance flag indicates presence of utterance.

2. The information processing system according to claim 1,
wherein the first device is worn on an ear of the first user.

3. The information processing system according to claim 1,
wherein the utterance flag includes bit data indicating presence or absence of utterance.

4. The information processing system according to claim 1,
wherein the first device transmits the utterance flag to the second device in a case where utterance of the first user is detected.

5. The information processing system according to claim 1,
wherein the first device transmits the utterance flag to the second device at regular intervals.

6. The information processing system according to claim 1,
wherein at least one of the first device or the second device functions as both the detection device and the hearing aid device.

7. The information processing system according to claim 1,
wherein the plurality of devices includes a plurality of the first devices each used by the first user, a plurality of the first users being different from each other.

8. The information processing system according to claim 1,
wherein the plurality of devices includes a plurality of the second devices each used by the second user, a plurality of the second users being different from each other.

9. The information processing system according to claim 1, further comprising:
a management device that manages the local communication network,
wherein the management by the management device includes at least one of addition, deletion, or setting of a device to participate in the local communication network, and
the setting includes setting to be used as the detection device and setting to be used as the hearing aid device.

10. The information processing system according to claim 1, further comprising:
a relay device that relays communication between the first device and the second device.

11. The information processing system according to claim 1,
wherein turning on the hearing aid processing includes gradually increasing a signal level of a hearing aid sound signal generated by the hearing aid processing.

12. The information processing system according to claim 1,
wherein the utterance flag indicates a probability of presence or absence of utterance, and
turning on the hearing aid processing includes setting a signal level of a hearing aid sound signal generated by the hearing aid processing to a level corresponding to the probability of presence or absence of utterance.

13. The information processing system according to claim 1,
wherein the hearing aid processing includes generating a hearing aid sound signal on a basis of a speaker feature amount of the first user.

14. The information processing system according to claim 1, further comprising:
an external device that controls the plurality of devices,
wherein control by the external device comprises:
at least one of forcibly halting ON of the hearing aid processing by the second device in a case where communication connection strength of the first device is low or forcibly halting transmission of the utterance flag by the first device in a case where the communication connection strength of the second device is low.

15. The information processing system according to claim 14,
wherein the external device forcibly halts an ON state of the hearing aid processing by the second device by transmitting an utterance flag indicating absence of utterance to the second device.

16. The information processing system according to claim 1,
wherein the second device adjusts a volume of at least one of hearing aid sound or other sound and simultaneously outputs the hearing aid sound and the other sound, the volume of at least one of the hearing aid sound or the other sound adjusted, and
the other sound includes at least one of content viewing sound or telephone voice.

17. A device that participates in a local communication network together with another device and executes hearing aid processing,
wherein the device turns on the hearing aid processing in a case where an utterance flag indicating presence or absence of utterance transmitted by the other device indicates presence of utterance.

18. A device that participates in a local communication network together with another device and detects utterance of a user,
wherein the device transmits an utterance flag indicating presence or absence of utterance to the other device.

19. An information processing method performed by a plurality of devices participating in a local communication network,
the plurality of devices comprising:
a first device used by a first user, the first device functioning as a detection device that detects utterance of the first user; and
a second device used by a second user, the second device functioning as a hearing aid device that executes hearing aid processing,
the information processing method comprising the steps of:
by the first device, transmitting an utterance flag indicating presence or absence of utterance to the second device, and
by the second device, turning on the hearing aid processing in a case where the utterance flag indicates presence of utterance.

20. A program for causing a computer to function as a plurality of devices participating in a local communication network,
wherein the plurality of devices includes:
a first device used by a first user, the first device functioning as a detection device that detects utterance of the first user; and
a second device used by a second user, the second device functioning as a hearing aid device that executes hearing aid processing for assisting hearing aid of the second user,
the first device transmits an utterance flag indicating presence or absence of utterance to the second device, and
the second device turns on the hearing aid processing in a case where the utterance flag indicates presence of utterance.
